(19) United States
(12) Patent Application Publication
(10) Pub. No.: US 2026/0034611 A1
(43) Pub. Date: Feb. 5, 2026

(54) AUTOMATIC FOCUSING METHOD, LASER PROCESSING APPARATUS AND SYSTEM, AND NON-TRANSITORY COMPUTER-READABLE STORAGE MEDIUM

(71) Applicant: Makeblock Co., Ltd., Shenzhen (CN)

(72) Inventor: Yuanxiu ZHANG, Shenzhen (CN)

(73) Assignee: Makeblock Co., Ltd., Shenzhen (CN)

(21) Appl. No.: 19/353,669

(22) Filed: Oct. 9, 2025

Related U.S. Application Data
(63) Continuation of application No. PCT/CN2025/089820, filed on Apr. 18, 2025.

(30) Foreign Application Priority Data
Apr. 25, 2024 (CN) 202410507479.1
Mar. 13, 2025 (CN) 202510299056.X

(51) Int. Cl. B23K 26/70; B23K 26/04

(52) U.S. Cl. CPC B23K 26/70; B23K 26/048

(57) ABSTRACT

An automatic focusing method, a laser processing apparatus and system, and a non-transitory computer-readable storage medium are provided. The automatic focusing method for a laser processing apparatus includes: controlling the first light output module to emit a first light spot onto a workpiece, and controlling the second light output module to emit a second light spot onto the workpiece; controlling the first light output module to move downward, and acquiring a plurality of images of the workpiece at different distances; and determining, based on the plurality of images, a distance between a processing surface of the workpiece and the first light output module or a thickness of the workpiece.

### RELATED APPLICATIONS

This application is a Continuation of PCT Patent Application No. PCT/CN2025/089820 having International filing date of Apr. 18, 2025, which claims the benefit of priority of China Patent Application No. 202510299056.X filed on Mar. 13, 2025 and No. 202410507479.1 filed on Apr. 25, 2024. The contents of the above applications are all incorporated by reference as if fully set forth herein in their entirety

### FIELD OF DISCLOSURE

The present application relates to a field of laser processing technologies, and more particularly to an automatic focusing method, a laser processing system, a laser processing apparatus, and a non-transitory computer-readable storage medium.

### BACKGROUND

In most current laser focusing methods, the distance between the light output module or other light-emitting components and the processing platform is manually adjusted to achieve laser focusing to ensure the processing quality. When workpieces of different thicknesses are processed with the same processing distance, variations in processing quality may occur.

### SUMMARY OF DISCLOSURE

In a first aspect, the present application provides an automatic focusing method for a laser processing apparatus. The laser processing apparatus includes a first light output module and a second light output module. The light output module is configured to emit a light spot for laser processing, and the second light output module is configured to emit a spot for indication. The automatic focusing method includes:
controlling the first light output module to emit a first light spot onto a workpiece, and controlling the second light output module to emit a second light spot onto the workpiece.
controlling the first light output module to move downward, and acquiring a plurality of images of the workpiece at different distances, each of the plurality of images including the first light spot and the second light spot.
determining, based on the plurality of images, a distance between a processing surface of the workpiece and the first light output module or a thickness of the workpiece.

In a second aspect, the present application provides a laser processing apparatus including a processing platform, a first light output module, a second light output module, an imaging module and a processor.

The processing platform is configured to support a workpiece.

The first light output module is configured to emit a first light spot onto the workpiece. A laser focus point of the first light output module is adjustable. The first light output module is movable upward or downward and configured for laser processing. The second light output module is configured to emit a second light spot for indication.

The imaging module is configured to acquire a plurality of images of the workpiece at different distances, the different distances being distances between the first light output module and the processing platform. The processor is configured to control movement of the first light output module and operation of the imaging module, and implement an automatic focusing method according to any one of embodiments mentioned foregoing.

In a third aspect, the present application provides a laser processing system. The laser processing system includes a laser processing apparatus and a terminal device.

The laser processing apparatus includes a first light output module, a second light output module and an imaging module.

The first light output module is configured to emit a light spot for laser processing, and a focal point of the first light output module is adjustable. The second light output module is configured to emit a light spot for indication. The imaging module is configured to acquire a plurality of images of the workpiece at different distances. The different distances are distances between the first light output module and the processing platform.

The terminal device is configured to control the first light output module to emit a first light spot onto a workpiece, control the second light output module to emit a second light spot onto the workpiece, control the first light output module to move downward, and control the imaging module to acquire a plurality of images of the workpiece at different distances, each of the plurality of images including the first light spot and the second light spot, and determine, based on the plurality of images, a distance between a processing surface of the workpiece and the first light output module or a thickness of the workpiece.

In a fourth aspect, the present application provides a non-transitory computer-readable storage medium storing instructions for performing an automatic focusing method. The instructions are executable by the processor to perform the automatic focusing method according to any one embodiment recited foregoing.

### BRIEF DESCRIPTION OF DRAWINGS

To more clearly illustrate the technical solutions in the embodiments of the present application, the drawings required for the description of the embodiments, or the related art are briefly introduced below. It is apparent that the drawings described below merely depict some embodiments of the present application. Other drawings may also be derived from the structures shown in these drawings by those skilled in the art.

FIG. 1 is a flowchart illustrating an automatic focusing method for a laser device according to some embodiments of the present application.

FIG. 2 is a flowchart illustrating the automatic focusing method according to some embodiments of the present application.

FIG. 3 is a detailed flowchart of step S300 illustrating the automatic focusing method according to some embodiments of the present application.

FIG. 4 is a detailed flowchart of step S322 illustrating the automatic focusing method according to some embodiments of the present application.

FIG. 5 is a detailed flowchart of step S400 illustrating the automatic focusing method according to some embodiments of the present application.

FIG. 6 is a detailed flowchart of step S410 illustrating the automatic focusing method according to some embodiments of the present application.

FIG. 7 is a detailed flowchart of steps S400 and S500 illustrating the automatic focusing method according to some embodiments of the present application.

FIG. 8 is a schematic block diagram illustrating a laser processing apparatus according to some embodiments of the present application.

FIG. 9 is a schematic block diagram of an automatic focusing device in the laser processing apparatus according to some embodiments of the present application.

FIG. 10 is a schematic diagram of an image used in the automatic focusing method according to some embodiments of the present application.

FIG. 11 is a first schematic diagram of a coarse focusing process in the automatic focusing method according to some embodiments of the present application.

FIG. 12 is a second schematic diagram of the coarse focusing process in the automatic focusing method according to some embodiments of the present application.

FIG. 13 is a first schematic diagram of a fine focusing process in the automatic focusing method according to some embodiments of the present application.

FIG. 14 is a second schematic diagram of the fine focusing process in the automatic focusing method according to some embodiments of the present application.

FIG. 15 is a third schematic diagram of the fine focusing process in the automatic focusing method according to some embodiments of the present application.

FIG. 16 is a fourth schematic diagram of the fine focusing process in the automatic focusing method according to some embodiments of the present application.

FIG. 17 is a structural schematic diagram of a laser processing apparatus according to some embodiments of the present application.

FIG. 18 is a structural schematic diagram of a laser processing apparatus according to some embodiments of the present application.

FIG. 19 is a structural schematic diagram of a laser processing apparatus according to some embodiments of the present application.

### DETAILED DESCRIPTION

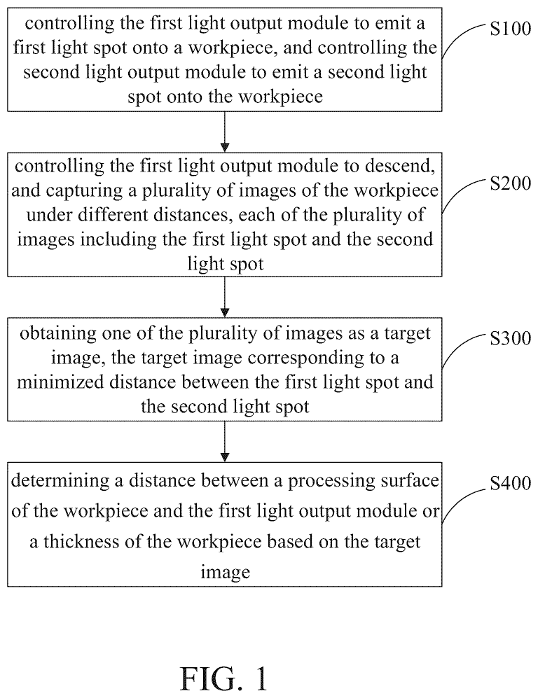

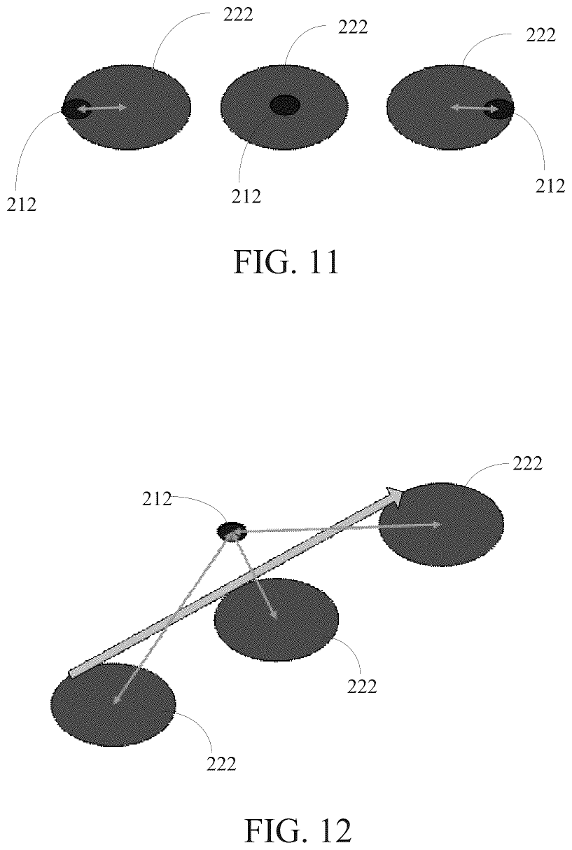

The technical solutions in the embodiments of the present application are described clearly and completely below with reference to FIGS. 1 to 19. Apparently, the embodiments merely represent a portion of all embodiments of the present application. Other embodiments, obtainable by those skilled in the art without inventive effort based on the disclosed embodiments, also fall within the scope of the present application.

It should be noted that directional indications in the embodiments refer to relative positions or movements among components under a specific posture, and such indications may vary when the posture changes.

In the present application, terms such as “first” and “second” are used solely for the purpose of description and should not be construed as indicating or implying relative importance, or as defining a quantity of the indicated technical features. Features labeled with “first” or “second” may explicitly or implicitly include at least one such feature. In addition, descriptions involving “A and/or B” refer to an arrangement including A, or B, or both A and B. The technical solutions of different embodiments may be combined if such combinations are implementable by those skilled in the art. Any combination that results in inconsistency or is not practically implementable shall be regarded as excluded from the scope of the present application.

In the related art, most laser focusing methods require manual adjustment of the distance between the light output module and the processing platform to achieve focus. When processing workpieces with different thicknesses, manual focusing leads to inconvenience and increased operational complexity.

To achieve automatic laser focus adjustment and enhance focusing accuracy, referring to FIGS. 1 to 19, the present application provides an automatic focusing method for a laser processing apparatus 200, a laser processing apparatus, a laser processing system, and a computer-readable storage medium. The automatic focusing method is applied to focus adjustment of a light output module such as a laser output module of the laser processing apparatus 200. Such light-emitting components are optionally disposed on the laser head 230 or separately mounted on the laser processing apparatus 200. The automatic focusing method is primarily applied to the laser processing apparatus 200, the laser processing system 1000, control devices for laser processing systems, and other equipment or systems configured for laser processing.

The executing entity of the present embodiment may be a computing service device equipped with data processing, network communication, and program execution capabilities, such as a tablet, personal computer, mobile phone, or server. In some embodiments, it may be an electronic device, laser processing control device, control system, control unit, or controller configured to perform the above functions. The controller primarily serves as the executing entity and is disposed into the components of the laser processing apparatus 200 or the laser processing system 1000, or arranged independently from the components of the laser processing system 1000.

The laser processing apparatus 200 includes a first light output module 210 and a second light output module 220. The first light output module 210 is configured to emit a light spot for laser processing, and the second light output module 220 is configured to emit a light spot for indication. The first light output module 210 is movable toward or away from a workpiece, or movable toward or away from the processing platform 100, or movable toward or away from both the workpiece and the processing platform 100, so as to adjust a focus point of the first light output module 210 and enable processing of workpieces with different thicknesses. The second light output module 220 is movable together with the first light output module 210 toward or away from a workpiece, or toward or away from the processing platform 100, or toward or away from both the workpiece and the processing platform 100.

It should be noted that although the light spot emitted from the first light output module 210 is primarily used for processing, a first light spot 212 emitted from the first light output module 210 has relatively low power and is mainly used for focusing. During the machining operation, the first light output module further emits a processing light spot having higher power than the first light spot, and the processing light spot is used to perform laser processing and effect a change in the workpiece. The second light output module 220 is configured to emit a second light spot 222, and the second light spot 222 primarily serves as an indication.

For ease of description, the following description primarily refers to the processor 400 within the terminal device 700 or the laser processing apparatus 200 as the execution entity. Referring to FIG. 1, the automatic focusing method includes following steps:

Step S100: controlling the first light output module 210 to emit the first light spot 212 onto the workpiece, and controlling the second light output module 220 to emit the second light spot 222 onto the workpiece.

Step S200: controlling the first light output module 210 to move downward, and acquiring a plurality of images of the workpiece at different distances, each of the plurality of images including the first light spot 212 and the second light spot 222. The different distances are distances between the first light output module 210 and the processing platform 100.

Step S300: obtaining one of the plurality of images as a target image, the target image corresponding to a smallest distance between the first light spot 212 and the second light spot 222.

Step S400: determining, based on the target image, a distance between a processing surface of the workpiece and the first light output module 210 or a thickness of the workpiece.

In some optional embodiments, the workpiece is placed on the processing platform 100. The first light output module 210 is configured to output a first light beam 211, and the second light output module 220 is configured to output a second light beam 221. The first light beam 211 is projected onto the workpiece to form the first light spot 212, and the second light beam 221 is projected onto the workpiece to form the second light spot 222.

In some embodiments, a laser or similar component serves as the first light output module 210 and is configured to emit the first light spot 212 for laser processing onto the workpiece. The first light output module 210 is movable relative to the processing platform 100 in the vertical direction, either upward or downward, to accommodate workpieces with different thicknesses. The second light output module 220 is configured, but not limited, to emit infrared light or ultraviolet light. In some embodiments, the second light output module 220 outputs one or more visible light spots such as red, blue, or yellow as the second light spot 222 onto the workpiece. The second light spot 222 is primarily used as a positional reference. By controlling the first light output module 210 to move downward and acquiring the plurality of images of the workpiece at different distances that include the first light spot 212 and the second light spot 222, the positions of the first light spots and second light spots on the workpiece at different distances are determined. One image corresponding to the smallest distance between the first light spot 212 and second light spot 222 among the plurality of images is obtained as the target image. Based on the target image, the distance between the processing surface of the workpiece and the first light output module 210, or the thickness of the workpiece, is determined. The distance or thickness provides key data for subsequent focus adjustment, allowing the focal point of the light output module to be accurately positioned on the processing surface of the workpiece so as to improve machining precision and efficiency.

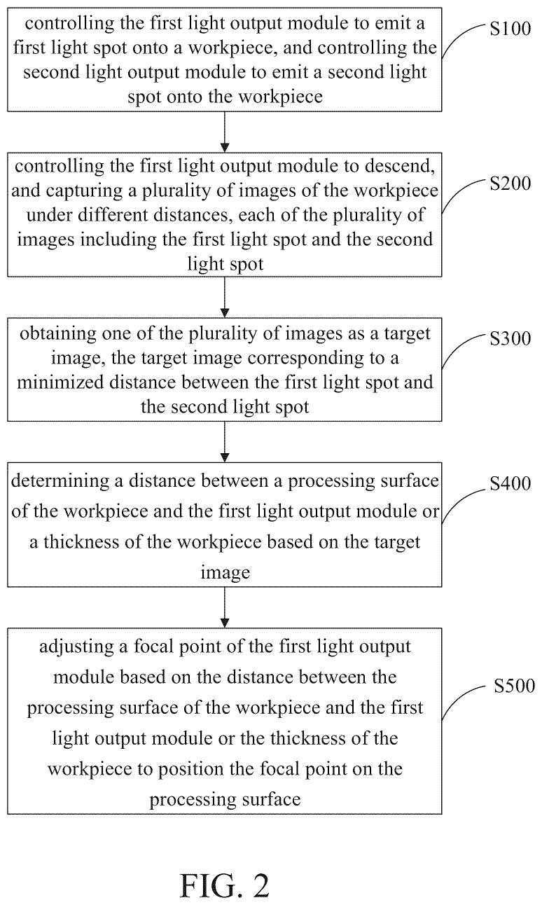

In some exemplary embodiments, referring to FIG. 2, after step S400 of determining, based on the target image, the distance between the processing surface of the workpiece and the first light output module 210, or the thickness of the workpiece, the automatic focusing method further includes step S500.

Step S500: adjusting a focal point of the first light output module 210 based on the distance between the processing surface of the workpiece and the first light output module 210 or the thickness of the workpiece to position the focal point on the processing surface.

In some embodiments of the present application, the focus point of the first light output module 210 is adjusted based on the distance between the processing surface of the workpiece and the first light output module 210, or the thickness of the workpiece, such that the focus point positions on the processing surface of the workpiece, thereby enabling automatic focusing, reducing manual involvement, minimizing operational errors, and lowering the difficulty of operation. After adjusting the focus point of the first light output module 210 configured to emit the first light spot 212 for laser processing, machining is performed to achieve precise processing, thereby accelerating the processing progress, optimizing the processing result, and enhancing customer satisfaction. Compared with other focusing methods in the related art, such as contact-based distance measurement and time-of-flight (TOF) distance measurement, the automatic focusing method of the present application reduces the use of detection components and lowers processing costs.

In the present application, a camera module 300 or another device with image acquisition and recognition capabilities is provided to acquire the plurality of images of the workpiece at different distances from the processing platform 100 during a downward movement of the first light output module 210. Each image includes the first light spot 212 and the second light spot 222. In some embodiments, by adjusting the distance between the first light output module 210 and the processing platform 100, or between the first light output module 210 and the processing surface of the workpiece placed on the processing platform 100, the distance between the first light spot 212 and the second light spot 222 is adjusted. The plurality of images, at different distances between the light output module of the laser processing apparatus 200 and the workpiece, are captured by the camera module 300 or another device with image acquisition capability. Based on the acquired images, the positions of the first light spot 212 and the second light spot 222 projected onto the workpiece at different distances between the first light output module 210 and the workpiece are determined. Among the acquired images, the image corresponding to the smallest distance between the first light spot 212 and the second light spot 222 is selected as the target image. The distance between the first light output module 210 and the workpiece corresponding to the target image is used as a focusing distance. The focus point of the first light output module 210 is further adjusted based on the focusing distance, so that the focal point is located on the processing surface of the workpiece and the distance between the first light spot 212 and the second light spot 222 satisfies the focusing requirement, enabling automatic adjustment of the laser focus, reducing the need for detection components and additional distance-measuring hardware, and lowering both operational complexity and processing cost. It should be noted that the present application mainly describes an example in which the first light output module 210 is controlled to move downward to capture the plurality of images of the workpiece at different distances, each image including the first light spot 212 and the second light spot 222. In some embodiments, the first light output module 210 is instead controlled to move upward to capture the plurality of images at different distances.

In some embodiments, the first light output module 210 and the second light output module 220 may be arranged as separate components or integrated into a single laser head 230. Accordingly, the first light output module 210 is individually controlled to move upward or downward to capture the plurality of images including the first light output module 210 and the second light output module 220 at different distances. In some embodiments, the first light output module 210 and the second light output module 220 are optionally moved upward or downward together to capture the plurality of images of the workpiece, each image including the first light spot 212 and the second light spot 222 at different distances. In this case, the emission direction of the first light spot 212 from the first light output module 210 is perpendicular to the surface of the processing platform 100, and the emission direction of the second light spot 222 from the second light output module 220 forms an inclination angle with the surface of the processing platform 100. The first light output module 210 and the second light output module 220 are configured as an integrated structure or arranged as separate independent structures.

In some embodiments, the first light output module 210 and the second light output module 220 are disposed on the laser processing apparatus 200 and located above the processing platform 100 relative to the laser processing apparatus 200. During execution of step S200, the first light output module 210 is controlled to move downward, and the plurality of images of the workpiece at different distances, each image including the first light spot 212 and the second light spot 222, are acquired. To obtain these images, the distance between the first light output module 210 and the workpiece is adjusted. The first light output module 210 is used to emit the light spot for laser processing and is movable upward or downward relative to the processing platform 100 or the workpiece placed on the processing platform 100.

In addition to adjusting the distance between the first light output module 210 and the workpiece by moving the first light output module 210 upward or downward as described above. The processing platform 100 is configured to move toward or away from the first light output module 210, so that the distance between the first light output module 210 and the workpiece is adjusted by changing the position of the processing surface.

In some embodiments of the present application, step S200 of controlling the first light output module 210 to move downward, and the acquiring a plurality of images of the workpiece at different distances, each of the plurality of images including the first light spot 212 and the second light spot 222 further includes: controlling the first light output module 210 to move sequentially from an initial position to a target position based on a preset adjustment distance, and at each target position, one image of the workpiece including the first light spot 212 and the second light spot 222 is captured, thereby obtaining the plurality of images.

In some embodiments, the first light output module 210 is controlled to move sequentially from the initial position to the target position according to the preset adjustment distance. One image is captured each time the first light output module 210 is moved. After multiple movements are performed according to a preset number of movements, the movement is stopped, and the plurality of images at different distances between the first light output module 210 and the workpiece are acquired.

During execution of step S300, one image is selected from the acquired plurality of images based on the smallest distance between the first light spot 212 and the second light spot 222. In some embodiments, the image in which the distance between a center point of the first light spot 212 and a center point of the second light spot 222 (or other calibration positions of the first and second light spots). In some embodiments, the image in which the distance is the shortest between a center point of the first light spot 212 and a center point of the second light spot 222, or between other calibration positions of the first light spot 212 and the second light spot 222, is selected as the target image.

During execution of step S400, the distance between the first light output module 210 and the workpiece corresponding to the smallest distance between the first light spot 212 and the second light spot 222 is used as the focusing distance. The focus point of the first light output module 210 is then adjusted so that the focus point is located on the processing surface of the workpiece.

In some embodiments of the present application, step S200 of controlling the first light output module 210 to move downward, and acquiring the plurality of images of the workpiece at different distances, each of the plurality of images including the first light spot 212 and the second light spot 222 further includes: controlling the first light output module 210 to move sequentially from the initial position to the target position based on the preset adjustment distance, one image is captured each time the first light output module 210 is moved, and the distance between the first light spot 212 and the second light spot 222 in the image is obtained. The distance between the center point of the first light spot 212 and the center point of the second light spot 222 is obtained, or alternatively, the distance between other calibration positions of the first light spot 212 and the second light spot 222 is obtained. Sequential movement from the initial distance to the target position refers to moving the first light output module 210 in the same direction such that the distance between the center point of the first light spot 212 and the center point of the second light spot 222 gradually decreases. For example, the first light output module 210 is controlled to move downward, causing the distance between the center points of the first light spot 212 and the second light spot 222 to gradually decrease.

When the emission direction of the first light spot 212 from the first light output module 210 is perpendicular to the surface of the processing platform 100, and the emission direction of the second light spot 222 from the second light output module 220 forms an inclination angle with the surface of the processing platform 100, the projection directions of the first light spot 212 and the second light spot 222 intersect rather than parallel. Therefore, when the distance between the center point of the first light spot 212 and the center point of the second light spot 222 reaches the smallest distance, continued movement of the first light output module 210 in the same direction causes the distance between the two center points to increase. Therefore, when the first light output module 210 has been moved multiple times, the distance between the center points of the first light spot 212 and the second light spot 222 in the currently acquired image becomes greater than that in the previously acquired image, this indicates that the smallest distance occurred in the previously acquired image. At this point, image acquisition is stopped, the distance between the first light output module 210 and the workpiece corresponding to the previously acquired image is used as the focusing distance, and the previously acquired image is determined as the target image.

During execution of step S500, the distance between the first light output module 210 and the workpiece, measured when the distance between the first light spot 212 and the second light spot 222 reaches the smallest distance, is used as the focusing distance. The focus point of the first light output module 210 is then adjusted so that the focal point is located on the processing surface of the workpiece.

In some embodiments of the present application, step S200 of controlling the first light output module 210 to move downward, and acquiring the plurality of images of the workpiece at different distances, each of the plurality of images including the first light spot 212 and the second light spot 222 further includes: controlling the first light output module 210 to move sequentially from the initial position to the target position based on the preset adjustment distance, one image is captured each time the first light output module 210 is moved. The movement is repeated until the distance between the center point of the first light spot 212 and the center point of the second light spot 222 reaches the smallest distance. At that point, the movement is stopped, and the distance between the first light output module 210 and the workpiece corresponding to the smallest distance is used as the focusing distance.

In some embodiments, a distance threshold is set such that when the distance between the center point of the first light spot 212 and the center point of the second light spot 222 is less than or equal to the preset distance threshold, the image is determined to contain the smallest distance between the first light spot 212 and the second light spot 222. Movement is then stopped when the two light spots overlap or when the distance between the center points of the first light spot 212 and the second light spot 222 reaches the smallest distance (or when the distance between other calibrated positions of the first light spot 212 and the second light spot 222 reaches the smallest distance). The distance between the first light output module 210 and the workpiece corresponding to such overlap or smallest distance is used as the focusing distance, and the corresponding image is determined as the target image.

During execution of step S400, the distance between the first light output module 210 and the workpiece corresponding to the smallest distance between the first light spot 212 and the second light spot 222 is used as the focusing distance to adjust the focus point of the first light output module 210, so that the focus point is located on the processing surface of the workpiece.

It should be noted that in the foregoing examples, the smallest distance between the center point of the first light spot 212 and the center point of the second light spot 222 in the acquired image includes both the case where the two center points overlap in the target image when the first light output module 210 is at a specific position, and the case where the two center points cannot overlap but are at their closest distance.

In some embodiments of the present application, it is necessary to acquire an image with the first light output module 210 at the initial position before movement. If the distance between the center point of the first light spot 212 and the center point of the second light spot 222 in the image acquired at the initial position has already reached the smallest distance, further movement is not required. In some embodiments, the movement direction of the first light output module 210 (in addition to downward movement, upward movement can also be used), the number of movements, and the adjustment distance are determined based on the distance between the center point of the first light spot 212 and the center point of the second light spot 222 in the image acquired at the initial position. The specific implementation varies depending on actual configurations and is not intended to be limiting.

The movement direction of the first light output module 210 is determined based on the distance between the center point of the first light spot 212 and the center point of the second light spot 222 in the image acquired at the initial position of the first light output module 210. For example, when the emission direction of the first light spot 212 is perpendicular to the surface of the processing platform 100, and the second light output module 220 is disposed on the right side of the first light output module 210 with its emission direction forming an inclination angle with the surface of the processing platform 100, if the second light spot 222 projected onto the workpiece is located to the right of the first light spot 212, the first light output module 210 is controlled to move downward. If the second light spot 222 is located to the left of the first light spot 212, the first light output module 210 is controlled to move upward. If the center point of the first light spot 212 overlaps with the center point of the second light spot 222, the first light output module 210 is kept at the current position, and the acquired image is determined as the target image.

For example, the first light output module 210 is implemented as a laser or another device configured to emit a laser beam for processing, the laser emitted from the first light output module 210 is focused to form the focal point. The energy is highest at the focal point, making it more effective for engraving, cutting, or marking the workpiece. To achieve better processing performance, the focal point of the first light output module 210 is typically adjusted to be located on the processing surface of the workpiece. In order to visually adjust the focus of the laser, during installation and calibration of the laser processing apparatus 200, it is preset that when the distance between the first light spot 212 and the second light spot 222 on the processing surface of the workpiece reaches the smallest distance, the focal point of the first light output module 210 is positioned on the surface of the workpiece.

The camera module 300 is specifically disposed on the light output modules (the first light output module 210 and the second light output module 220), the laser processing apparatus 200, outside the laser processing apparatus 200, or at any other suitable position, and is used to capture images of the workpiece or the processing platform 100. By recognizing image features such as pixel values, image size, and image shape, the first light spot 212 and the second light spot 222 can be identified, and more specifically, the center points or other calibrated positions of the first light spot 212 and the second light spot 222 can be determined. In some embodiments, the image acquired by the imaging module 300, as shown in FIG. 10, is directly displayed through a user interface, with different colors used to represent the light spots emitted from the first light output module 210 and the second light output module 220 onto the workpiece. To distinguish the light spots emitted from the first light output module 210 and the second light output module 220 onto the workpiece, the first light output module 210 and the second light output module 220 are configured to emit the first light spot 212 and the second light spot 222 in different colors. Alternatively, after recognizing the first light spot 212 and the second light spot 222, the imaging module 300 automatically display the two light spots in different colors. The specific implementation varies depending on actual settings and is not limited herein.

The second light spot 222 is used as a positional reference. Since the light beam is projected radially onto the workpiece and/or the processing platform 100 and appears in the form of a light spot, the brightness varies across different regions of the light spot, with the maximum brightness occurring at the center of the beam. When controlling the first light output module 210 to emit a processing light spot having higher power for processing, the light utilization efficiency is also maximized at the center of the beam. Accordingly, the first light output module 210 is controlled to move downward or upward, and the plurality of images of the workpiece at different distances including the first light spot 212 and the second light spot 222 are acquired. The distance between the first light spot and the second light spot is determined based on the distance between the center point of the first light spot 212 and the center point of the second light spot 222. The distance between the first light output module 210 and the workpiece corresponding to the smallest distance between the center points of the first light spot 212 and the second light spot 222 is used as the focusing distance, thereby maximizing focusing accuracy, improving processing precision, and reducing processing error. Compared with focusing methods in the related art, such as contact-based distance measurement and time-of-flight (TOF) distance measurement, the automatic focusing method of the present application reduces the use of detection components and additional distance-measuring hardware, thereby lowering operational complexity and processing cost.

In some embodiments, step S300 of obtaining one of the plurality of images as the target image, the target image corresponding to a smallest distance between the first light spot and the second light spot includes:

In response to one of the plurality of images including the center point of the first light spot coinciding with the center point of the second light spot, determining that the image corresponding to the smallest distance between the first light spot 212 and the second light spot 222.

In some embodiments, step S300 of obtaining one of the plurality of images as the target image, the target image corresponding to a smallest distance between the first light spot and the second light spot includes:

In response to none of the plurality of images including the center point of the first light spot coinciding with the center point of the second light spot, determining one of the plurality of images that corresponds to the smallest distance between the first light spot 212 and the second light spot 222.

In these embodiments, the first light output module 210 is controlled to move, and the plurality of images are acquired at different distances between the first light output module 210 and the workpiece. As shown in FIG. 12, the distances between the center point of the first light spot 212 and the center point of the second light spot 222 in the acquired images are compared to identify the image corresponding to the smallest distance as the target image. This comparison is also used to determine the distance between the first light output module 210 and the workpiece at the smallest distance as the focusing distance, which is further used to control movement of the first light output module 210 for adjusting the focus position of the laser.

In the present application, since the emission direction of the first light spot 212 from the first light output module 210 is perpendicular to the surface of the processing platform 100, and the emission direction of the second light spot 222 from the second light output module 220 forms an inclination angle with the surface of the processing platform 100, it is further possible to directly calculate whether overlap between the first light spot 212 and the second light spot 222 is feasible based on the positions of the first light spot 212 and the second light spot 222 in the image acquired when the first light output module 210 is at the initial position, and based on the inclination angle formed between the emission direction of the second light beam 221 and the surface of the processing platform 100.

If overlap is possible, the distance between the first light output module 210 and the workpiece corresponding to the overlap between the first light spot 212 and the second light spot 222 is directly used as the focusing distance. Based on the focusing distance, the first light output module 210 is further controlled to move, thereby adjusting the focus position of the first light output module 210 so that the focus point is located on the processing surface of the workpiece.

If overlap is not possible, the smallest distance is defined as the closest distance between the first light spot 212 and the second light spot 222, and the corresponding distance between the first light output module 210 and the workpiece is used as the focusing distance. The first light output module 210 is then moved based on the focusing distance to adjust the focal position such that the focal point is located on the processing surface of the workpiece. The specific method for adjusting the focal position of the first light output module 210 varies depending on actual implementation and is not limited herein.

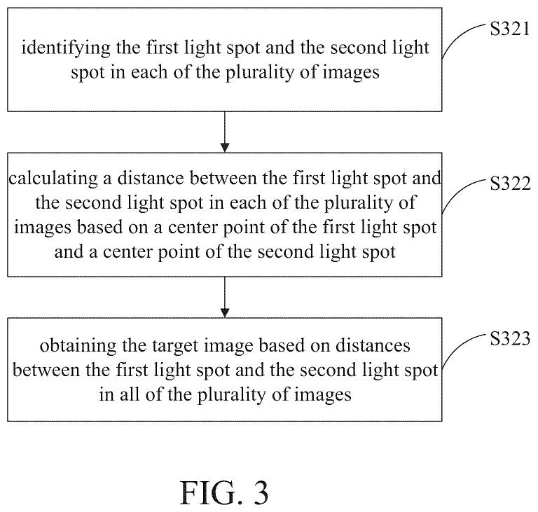

Referring to FIG. 3, in some embodiments, step S300 of obtaining one of the plurality of images as the target image, the target image corresponding to the smallest distance between the first light spot 212 and the second light spot 222 includes:

Step S321: identifying the first light spot 212 and the second light spot 222 in each of the plurality of images.

Step S322: calculating a distance between the first light spot 212 and the second light spot 222 in each of the plurality of images based on the center point of the first light spot 212 and the center point of the second light spot 222.

Step S323: obtaining the target image based on the distances between the first light spot 212 and the second light spot 212 in all of the plurality of images.

The first light spot 212 and the second light spot 222 in each image are identified using an algorithm, and the distance between them is calculated using image processing techniques. In some embodiments, the center points of the first light spot 212 and the second light spot 222 in each image are first determined. The distance between the center points of the first light spot 212 and the second light spot 222 is then calculated as a spot distance. By comparing the spot distances across the plurality of images, the image with the smallest distance between the first light spot 212 and the second light spot 222 is selected as the target image for subsequent analysis or processing.

In some embodiments, to improve the accuracy of spot recognition, image processing techniques are used to analyze the brightness, color, shape, and other features of each image, so as to identify the first light spot 212 and the second light spot 222 matching preset conditions, such as predefined brightness thresholds or templates. Such techniques include preprocessing steps such as denoising, enhancement, edge detection, and threshold segmentation. The specific implementation is adjusted based on actual requirements and is not limited herein.

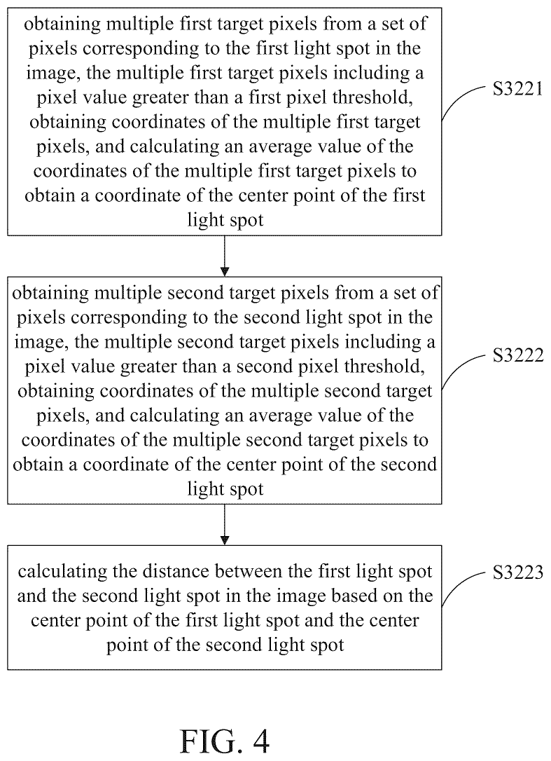

Referring to FIGS. 4 and 10, in some embodiments, step S322 of calculating a distance between the first light spot 212 and the second light spot 222 in each of the plurality of images based on the center point of the first light spot 212 and the center point of the second light spot 222 includes:

Step S3221: obtaining multiple first target pixels from a set of pixels corresponding to the first light spot 212 in the image, the multiple first target pixels including pixel values greater than a first pixel threshold, and obtaining coordinates of the multiple first target pixels, and calculating an average value of the coordinates of the multiple first target pixels to obtain a coordinate of the center point of the first light spot 212.

Step S3222: obtaining multiple second target pixels from a set of pixels corresponding to the second light spot 222 in the image, the multiple second target pixels including pixel values greater than a second pixel threshold, and obtaining coordinates of the multiple second target pixels, and calculating an average value of the coordinates of the multiple second target pixels to obtain a coordinate of the center point of the second light spot 222.

Step S3223: calculating the distance between the first light spot 212 and the second light spot 222 in the image based on the center point of the first light spot 212 and the center point of the second light spot 222.

A light spot typically consists of a group of pixels having relatively high pixel values. To determine the center position of a light spot and calculate the distance between two light spots, a first pixel threshold is set to filter out pixels in the image whose values exceed the threshold. These filtered pixels form the set representing the first light spot 212. The average of the coordinates of these pixels is then calculated to obtain the center point coordinates of the first light spot 212. Similarly, a second pixel threshold is set to filter out a set of pixels forming the second light spot 222, and the average of the coordinates of these pixels is calculated to obtain the center point coordinates of the second light spot 222. In some embodiments, any one of the pixel values 80, 85, or 90, or any other arbitrary pixel value, is used as the first pixel threshold. All pixels in the image corresponding to the first light spot 212 that have pixel values greater than the first pixel threshold are identified as first target pixels. The coordinates of these first target pixels are then acquired, and the average of the coordinates is calculated. The resulting average value is used as the coordinate of the center point of the first light spot 212 in the image. Similarly, any one of the pixel values 80, 85, or 90, or any other arbitrary pixel value, is used as the second pixel threshold. Based on this threshold, the coordinate of the center point of the second light spot 222 is obtained. Then, the distance between the two center points is calculated using their respective coordinates. By identifying the center points of the first light spot 212 and the second light spot 222 in each image and calculating the distance between them, the spot distances across the plurality of images can be compared to select the image with the smallest spot distance. This facilitates determining the optimal focusing position between the processing surface of the workpiece and the first light output module 210.

It should be noted that during the execution of steps S100 to S300 of the above-mentioned automatic focusing method, the first light output module 210 and the second light output module 220 remain turned on. During the execution of step S400 and the related steps, the second light output module 220 is optionally turned off, or both the first light output module 210 and the second light output module 220 remains turned on.

In some embodiments, steps S100 to S300 are sufficient to complete automatic focusing independently, without the need to execute subsequent fine focusing steps. In some embodiments, after executing step S300, the lifting distance corresponding to the target image is obtained based on the target image, and the focusing distance is determined accordingly. Automatic focusing is then achieved by controlling the first light output module 210 to move to the position corresponding to the smallest distance between the first light spot 212 and the second light spot 222, without requiring further fine-tuning operations.

In some embodiments, when the automatic focusing method further includes a fine focusing step or when higher focusing accuracy is required, steps S100 to S300 serve as a coarse focusing step. This coarse focusing step provides accurate focusing range and distance information for the subsequent fine focusing in step S500, ensuring that the focus point of the first light output module 210 is precisely located on the processing surface of the workpiece, reducing the difficulty of the subsequent fine focusing and optimizing processing accuracy and quality.

In some embodiments, to further adjust the focus position of the laser and improve focusing precision, steps S100, S200, S300, and related steps are used to perform coarse focusing by controlling the first light output module 210 to move to a position corresponding to the smallest distance between the first light spot 212 and the second light spot 222. Fine focusing is then performed through corresponding fine focusing steps. In the coarse focusing stage, the first light output module 210 is controlled to move to the position corresponding to the smallest distance between the first light spot 212 and the second light spot 222. Fine focusing is then performed through the related steps of the fine adjustment process. During the coarse focusing phase, the first light output module 210 is moved and the target image is acquired, such that the distance between the first light spot 212 and the second light spot 222 is minimized, thereby constraining the focal point of the first light output module 210 within a certain range. Subsequently, in the fine focusing stage, based on the target image, the X coordinate and/or Y coordinate of the center point of the first light spot 212 in the target image is acquired. Based on the X and/or Y coordinate of the center point of the first light spot 212 and a predefined mapping relationship, the distance between the processing surface of the workpiece and the first light output module 210, or the thickness of the workpiece, is calculated. Based on the calculated distance or thickness, the movement distance of the first light output module 210 is determined. The first light output module 210 is then controlled to move upward or downward to adjust its focal point so that the focal point is positioned on the processing surface, thereby achieving automatic focusing. This enables precise processing, improves machining accuracy, and optimizes the processing effect.

Through the above-mentioned coarse focusing and subsequent fine focusing, the focal point of the first light output module 210 can be precisely adjusted to accommodate workpieces of different thicknesses, thereby further improving processing accuracy and efficiency. In some embodiments, coarse focusing ensures that the focusing accuracy remains within 3 mm, while fine focusing after coarse focusing ensures that the focusing accuracy is maintained at approximately 0.5 mm.

In some embodiments, step S500 of adjusting the focal point of the first light output module 210 based on the distance between the processing surface of the workpiece and the first light output module 210 or the thickness of the workpiece to position the focal point on the processing surface includes: using the distance between the first light output module 210 and the workpiece corresponding to the target image as a focusing distance; and adjusting the focal point of the first light output module 210 based on the focusing distance, so as to position the focal point on the processing surface of the workpiece. In this case, step S500 is used to perform coarse focusing.

It should be noted that when the automatic focusing method further includes a fine focusing step or when higher focusing accuracy is required, a fine focusing process is also included. Coarse focusing is performed through steps S100 to S300 to provide accurate focusing range and distance information for the subsequent fine focusing in step S500. This ensures that the focal point of the first light output module 210 is precisely aligned with the processing surface of the workpiece, reduces the difficulty of fine focusing, and improves processing precision and quality. In this manner, the focal point of the first light output module 210 can be accurately adjusted to accommodate workpieces of different thicknesses, thereby further enhancing processing accuracy and efficiency.

The present application implements fine focusing based on the principle of triangulation. Specifically, the first light spot 212 emitted from the first light output module 210 is directed perpendicular to the surface of the processing platform 100 and is used for laser processing. The second light spot 222 emitted from the second light output module 220 is directed at an inclination angle relative to the surface of the processing platform 100 and serves as an auxiliary for positioning or indication. During the downward (or upward) movement of the first light output module 210, the imaging module 300 captures the plurality of images of the workpiece that include both the first light spot 212 and the second light spot 222. As the light output modules (the first light output module 210 and the second light output module 220) move, the positions of the first light spot 212 and the second light spot 222 change accordingly. The principle of triangulation is applied to these captured images, and the position change of the light output modules relative to the surface of the workpiece is determined by analyzing the positional changes of the first light spot 212 and the second light spot 222. Based on known geometric relationships and system parameters, such as the inclination angle of the second light output module 220, the distance between the light output modules and the surface of the workpiece can be calculated, and the thickness of the workpiece can be further determined. For example, if the thickness or shape of a certain portion of the workpiece is known, the thickness can be indirectly obtained by calculating the difference in distance between that portion and the light output modules. Since the first light output module 210 vertically projects the first light spot 212 onto the workpiece while the second light output module 220 projects the second light spot 222 at an inclination angle, the center position of the second light spot 222 varies with the distance to the workpiece, whereas the position of the first light spot 212 remains relatively stable. If the second light spot 222 is selected to determine the distance between the processing surface of the workpiece and the first light output module 210, or to calculate the thickness of the workpiece, higher requirements are imposed on the surface area of the workpiece or the processing platform 100, the projection position of the second light spot 222, and the movement distance of the laser head 230. In addition, simultaneous projection of the first light spot 212 and the second light spot 222 affects the accuracy of focus adjustment.

Accordingly, the embodiments of the present application adopt the first light spot 212, and the position information of the first light output module 210 is determined based on the coordinate position of the center point of the first light spot 212. The following description is primarily based on the example of adjusting the focus of the first light output module 210 using the target image, so that the focal point is positioned on the processing surface of the workpiece.

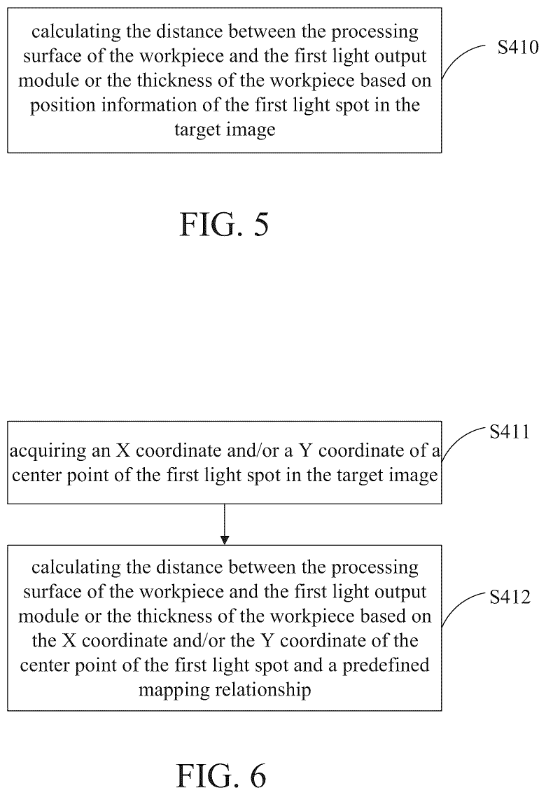

Referring to FIG. 5, in some embodiments, step S400 of determining, based on the target image, the distance between the processing surface of the workpiece and the first light output module or the thickness of the workpiece includes:

Step S410: calculating the distance between the processing surface of the workpiece and the first light output module 210 or the thickness of the workpiece based on position information of the first light spot 212 in the target image.

It can be understood that the distance between the processing surface of the workpiece and the first light output module 210 is calculated based on the position information of the first light spot 212 in the target image. In some embodiments, the thickness of the workpiece is calculated based on the position information of the first light spot 212 in the target image. In another example, the distance between the processing surface of the workpiece and the first light output module 210 is calculated based on the position information of the first light spot 212 in the target image, and the thickness of the workpiece is further derived therefrom.

These embodiments are primarily described by taking, as an example, the calculation of the distance between the processing surface of the workpiece and the first light output module 210 based on the position information of the first light spot 212 in the target image. Related embodiments in which the thickness of the workpiece is calculated based on the position information of the first light spot 212, or in which the distance between the processing surface of the workpiece and the first light output module 210 is calculated and the thickness of the workpiece is further derived, are referred to accordingly and will not be described in detail herein. In some embodiments, by acquiring the target image (i.e., the image corresponding to the smallest distance between the first light spot 212 and the second light spot 222), the position of the first light spot 212 in the image can be accurately determined. Then, using optical principles and known geometric relationships, such as the principle of triangulation, the distance between the first light output module 210 and the processing surface of the workpiece is calculated. Based on this distance, or the thickness of the workpiece, the first light output module 210 is moved by the lifting module 500 or other mechanisms to adjust its focal point so that it is positioned on the processing surface of the workpiece. In this way, automatic focusing is achieved, which improves the precision and efficiency of subsequent processing.

Referring to FIG. 6, in some embodiments, step S410 of calculating the distance between the processing surface of the workpiece and the first light output module or the thickness of the workpiece based on position information of the first light spot in the target image includes:

Step S411: acquiring an X coordinate and/or a Y coordinate of a center point of the first light spot 212 in the target image.

Step S412: calculating the distance between the processing surface of the workpiece and the first light output module 210 or the thickness of the workpiece based on the X coordinate and/or the Y coordinate of the center point of the first light spot 212 and a predefined mapping relationship.

By acquiring the X coordinate and/or Y coordinate of the center point of the first light spot 212 in the target image (i.e., the image in which the distance between the first light spot 212 and the second light spot 222 is the shortest), key data can be provided for subsequent distance or thickness calculations. In some embodiments, the coordinate value of the center point of the first light spot 212 and a predefined mapping relationship are used to calculate the distance between the processing surface of the workpiece and the first light output module 210, or to further derive the thickness of the workpiece.

The predefined mapping relationship is used to establish the correspondence between the coordinate position of the center point of the light spot and the position information of the first light output module 210 based on the principle of triangulation. The predefined mapping relationship is typically established through experimental or calibration processes. It defines the correspondence between the position of the center point of the first light spot 212 in the image (i.e., the X coordinate and/or Y coordinate) and the distance between the first light output module 210 and the processing surface of the workpiece. This relationship is, but not limited to, linear, nonlinear, or based on a mathematical model. In other words, under a known predefined mapping relationship between the coordinate position of the center point of the first light spot 212 and the position of the first light output module 210, which corresponds to either the distance between the processing surface of the workpiece and the first light output module 210 or the thickness of the workpiece, the position information of the light output module, such as the distance to the processing surface or the thickness of the workpiece, can be directly determined based on the coordinate position of the center point of the first light spot 212. The specific implementation varies depending on actual requirements and is not intended to be limiting.

Steps S411 and S412 achieve precise calculation of the distance between the processing surface of the workpiece and the light output module, or the thickness of the workpiece, by obtaining the coordinate information of the light spot and applying the predefined mapping relationship. This process provides key data for subsequent focus adjustment, ensuring that the focal point of the light output module is accurately aligned with the processing surface of the workpiece, thereby improving processing precision and efficiency.

In implementation, the predefined mapping relationship between the coordinate position of the center point of the first light spot 212 and the position of the first light output module 210 is directly obtained by, for example, invoking a pre-stored calibration file. In some embodiments, the relationship is determined based on the principle of triangulation, and the predefined mapping relationship is established by repeatedly adjusting the focal position of the first light output module 210 and recording the corresponding coordinate positions of the center point of the first light spot 212. In the present application, the predefined mapping relationship between the coordinate position of the center point of the first light spot 212 and the position of the first light output module 210 is primarily determined by directly invoking a pre-stored calibration file. This approach effectively reduces operational difficulty and complexity, facilitates precise machining, and improves processing accuracy.

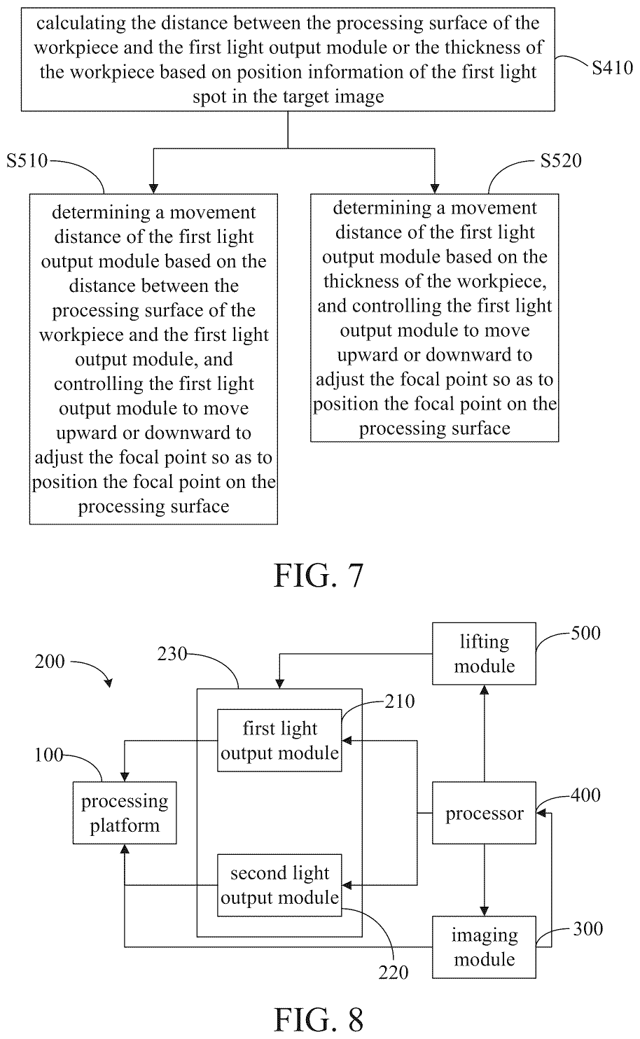

Referring to FIG. 7, as one example, step S500 of adjusting the focal point of the first light output module based on the distance between the processing surface of the workpiece and the first light output module 210 to position the focal point on the processing surface includes:

Step S510: determining the movement distance of the first light output module 210 based on the distance between the processing surface of the workpiece and the first light output module 210; and controlling the first light output module 210 to move upward or downward to adjust the focal point, so as to position the focal point on the processing surface.

The movement distance is determined based on the actual distance between the processing surface of the workpiece and the first light output module 210. For example, the movement distance is calculated by subtracting the focal length of the first light output module 210 from the actual distance between the processing surface of the workpiece and the first light output module 210. In this process, based on the determined actual distance between the processing surface of the workpiece and the first light output module 210, the required upward or downward movement distance of the first light output module 210 can be accurately calculated to ensure that the laser focal point precisely falls on the processing surface of the workpiece. This method reduces computational complexity while maintaining high precision and efficiency in laser processing, and is particularly suitable for applications requiring high measurement accuracy.

Referring to FIG. 7, as one example, step S500 of adjusting the focal point of the first light output module 210 based on the thickness of the workpiece to position the focal point on the processing surface includes:

Step S520: determining the movement distance of the first light output module 210 based on the thickness of the workpiece; and controlling the first light output module 210 to move upward or downward to adjust the focal point, so as to position the focal point on the processing surface.

The movement distance is determined based on the thickness of the workpiece. In this case, it is assumed that the light spot of the first light output module 210 is located at the center of the processing platform 100 (or another specified position). Based on this assumed position and the thickness of the workpiece, the required movement distance of the first light output module 210 can be calculated to align the laser focal point with the processing surface of the workpiece having the corresponding thickness. For example, based on the thickness of the workpiece, the distance between the first light output module 210 and the processing surface of the workpiece can be determined. The movement distance is then calculated by subtracting the focal length of the first light output module 210 from this distance. This method simplifies the calculation process by directly using the workpiece thickness to determine the movement distance, making it suitable for application scenarios where a certain level of accuracy in workpiece thickness measurement is required.

As an example, determining the distance between the processing surface of the workpiece and the first light output module 210 based on the target image includes: determining the distance between the processing surface of the workpiece and the first light output module 210 based on the descent distance of the first light output module 210 corresponding to the target image. The distance is obtained by summing the descent distance of the first light output module 210 corresponding to the target image and a preset distance, which is the focal length or the distance corresponding to the smallest distance between the two light spots. This resulting distance represents the distance between the first light output module 210 and the processing surface of the workpiece when the first light output module 210 is in the origin position.

As an example, determining the thickness of the workpiece based on the target image includes: determining the distance between the processing surface of the workpiece and the first light output module 210 based on the descent distance of the first light output module 210 corresponding to the target image; and further determining the thickness of the workpiece based on the obtained distance. The thickness of the workpiece is calculated by subtracting the distance between the processing surface of the workpiece and the first light output module 210 from a known distance between the first light output module 210 at the origin position and the processing base plate.

In related art, contact-based distance measurement and time-of-flight (TOF) distance measurement are commonly used for focusing. Contact-based distance measurement requires a detection component, such as a probe, to detect the distance between the optical component and the processing platform 100, and the laser focus is adjusted based on the detected distance. TOF distance measurement adjusts the laser focus by measuring the flight time of light at a specific frequency. However, these methods require additional detection components and distance measurement hardware, which increases processing cost and operational complexity.

In these embodiments, through the foregoing step S421 or step S422, the focus point of the first light output module 210 is adjusted by controlling the first light output module 210 to move upward or downward, so that the focus point is located on the processing surface to achieve automatic focusing. Unlike contact-type ranging and TOF ranging in related technologies, the embodiments of the present application can effectively reduce the use of detection components and additional distance measurement hardware. Based on the target image, the focus point of the first light output module 210 is adjusted so that the focus point is located on the processing surface of the workpiece, thereby achieving automatic focusing, reducing manual involvement, effectively reducing operational errors, lowering operational difficulty, enabling relatively precise processing after the focus point of the first light output module 210 is adjusted, and optimizing processing performance.

In the present embodiments, the specific implementation process for determining a preset mapping relationship between the coordinate position of the center point of the first light spot 212 and the position of the first light output module 210 is as follows:

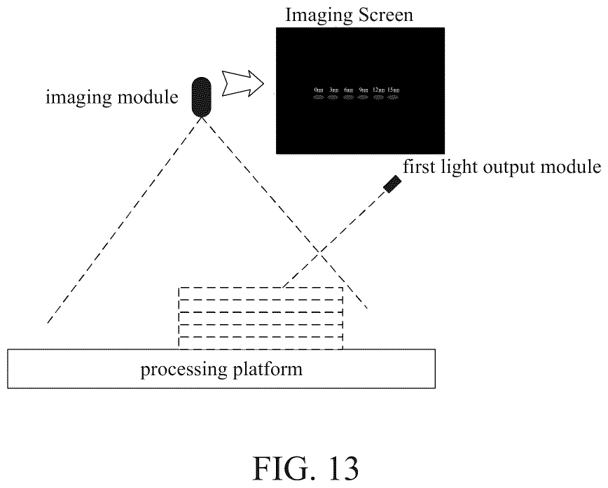

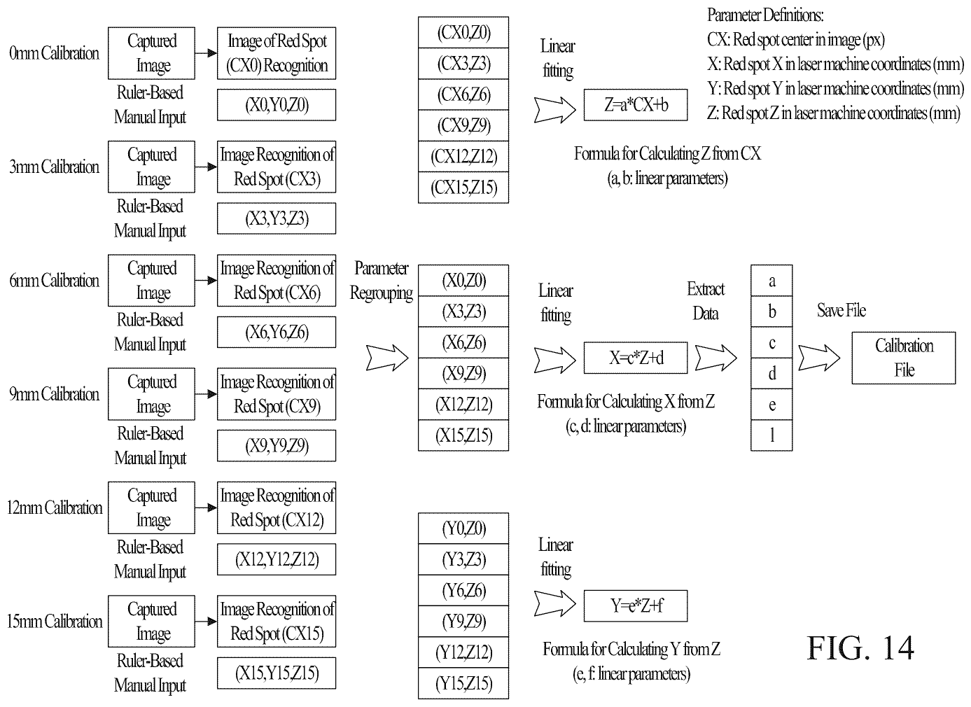

Referring FIGS. 13 and 14, FIGS. 13 and 14 illustrate that, during factory calibration of the processing device, a predefined mapping relationship between the coordinate position of the center point of the first light spot 212 and the position of the first light output module 210 is determined. For calibration at each height, a set of parameters is obtained from captured images, including a pixel position CX of the center point of the first light spot 212 of the first light output module 210 and a spatial position (X, Y, Z) of the first light output module 210 corresponding to the pixel position. The set of parameters is then regrouped. The center point of the first light spot 212 is defined as an irradiation point. For example, when performing a calibration process for one height, a pixel position CX of the irradiation point and a spatial position (X, Y, Z) of the irradiation point are obtained to form one set. This set is regrouped in pairs of the pixel position and each coordinate value to obtain three sets of parameters, namely (CX, Z), (X, Z), and (Y, Z). For each height, three sets of parameters are obtained through the regrouping in the same manner. Across all heights, identical types of parameter sets are aggregated together. For example, all (CX, Z) sets are aggregated and subjected to linear fitting. As an example, linear fitting is performed on (CX0, Z0), (CX3, Z3), (CX6, Z6), (CX9, Z9), (CX12, Z12), and (CX15, Z15) to match the regrouping performed. Through the linear fitting, a mapping from the spatial position of the irradiation point to coordinate values is obtained. The mapping specifically includes a mapping from the spatial position to a Z-axis coordinate value, a mapping from an X-axis coordinate value to a Z-axis coordinate value, and a mapping from a Y-axis coordinate value to a Z-axis coordinate value. In this way, a mapping from the pixel position of the irradiation point to the spatial position of the irradiation point is obtained.

The mapping from the pixel position of the irradiation point to the spatial position of the irradiation point indicates the relationship between the pixel position of the irradiation point and coordinate values in the spatial position of the irradiation point, as well as the relationship among the coordinate values. The relationship can be represented by a linear function and coefficients thereof. Therefore, coefficients obtained through linear fitting for use in the linear function corresponding to the pixel position of the irradiation point, the coordinate values in the spatial position of the irradiation point, and the relationship among the coordinate values are determined. The corresponding linear function can be determined from the coefficients, thereby obtaining the relationship between the pixel position of the irradiation point and the spatial position of the irradiation point, namely, the mapping relationship between the coordinate position of the center point of the first light spot 212 and the position of the first light output module 210.

A linear function obtained through linear fitting between the pixel position CX of the irradiation point and a coordinate value, namely a Z-axis coordinate value, is expressed as Z=a·CX+b. A linear function obtained through linear fitting between an X-axis coordinate value and the Z-axis coordinate value is expressed as X=c·Z+d. A linear function obtained through linear fitting between a Y-axis coordinate value and the Z-axis coordinate value is expressed as Y=c·Z+f. Coefficients a, b, c, d, and e are read from a calibration file obtained by executing a calibration process. Therefore, coefficients obtained through the linear fitting are extracted to form the calibration file. Correspondingly, in measurement of a measurement point being performed, the calibration file only needs to be called to obtain a calibration relationship between the pixel position of the irradiation point and the spatial position of the irradiation point, namely, a predefined mapping relationship between the coordinate position of the center point of the first light spot 212 and the position of the first light output module 210. Since the irradiation is located above the measurement point in a numerical control machine coordinate system, the spatial position of the irradiation point is identical to the spatial position of the measurement point. Therefore, in the measurement of the measurement point performed in the embodiment, the spatial position of the measurement point can be obtained by substituting the pixel position of the irradiation point into the predefined mapping relationship.

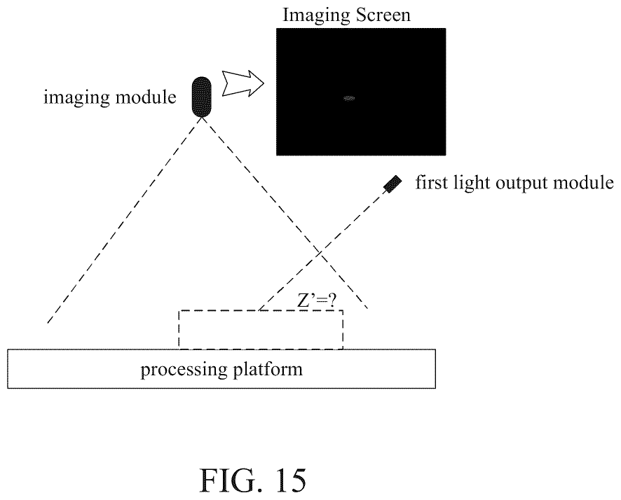

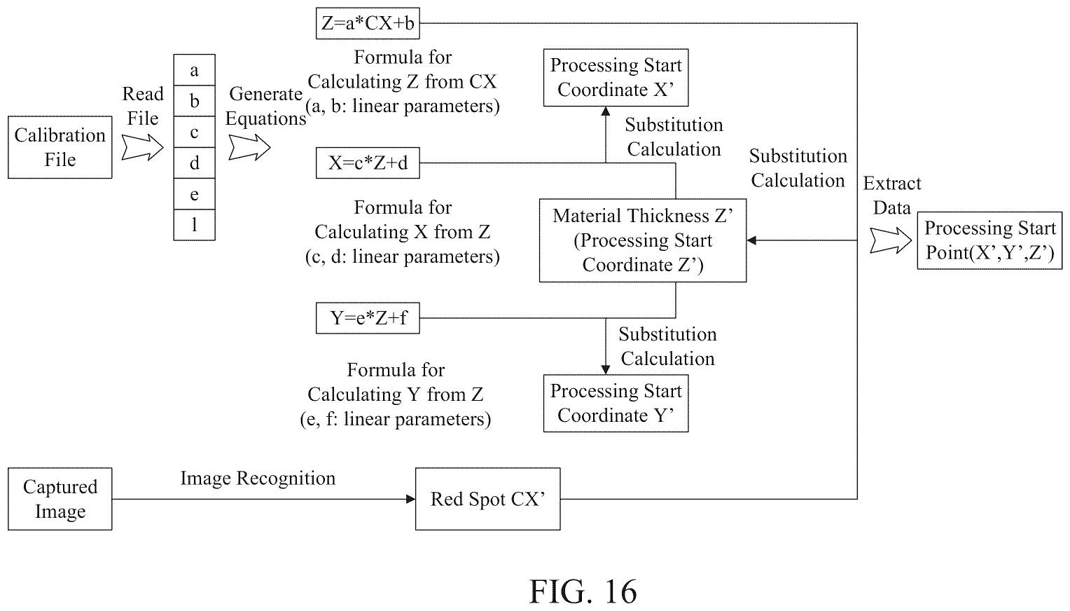

Referring FIGS. 15 and 16, FIGS. 15 and 16 illustrate schematic diagrams of a measurement process for fine focusing. During specific calculation, coefficients are first read from the calibration file. Formulas are then constructed based on the read coefficients, namely, a linear function Z=a·CX+b representing the spatial position of the measurement point and a coordinate value, and linear functions X=c·Z+d and Y=c·Z+f representing relationships among the coordinate values.

For an image acquired by the imaging module 300, a red spot corresponding to a center point of the first light spot 212 is identified to obtain a spatial position CX′. The coordinates Z′, Y′, and X′ are then sequentially calculated from a linear function constructed in advance, and the coordinates Z′, Y′, and X′ define a spatial position of a measurement point corresponding to a position of the first light output module 210. For obtaining a pixel position of an irradiation point from a captured image, the captured image represents the irradiation point formed by a light beam in the numerical control machine, and the irradiation point in the image is expressed in pixels. Image recognition is performed on the captured image to identify the pixel representing the irradiation point, and the pixel position of the irradiation point is thus obtained. By repeating the above process, pixel positions of irradiation points corresponding to multiple measurement points in a point array are obtained from captured images. Based on the measurement point array, multiple measurement points are measured for processing a workpiece, thereby enabling more accurate determination of spatial positions of regions where the measurement points are located.

FIGS. 13 and 15 are provided for illustration of the present application and are not intended to limit the scope of the present application. In practice, the laser output from the first light output module 210 is oriented vertically to a workpiece, and the imaging module 300 is inclined relative to the workpiece.

The position of the first light output module 210 can be further obtained according to actual settings and specific solutions of related technologies, without being limited herein.

In some embodiments of the present application, referring to FIGS. 8, 17, and 18, a laser processing apparatus 200 is provided. The laser processing apparatus 200 includes a processing platform 100, a first light output module 210, a second light output module 220, an imaging module 300, and a processor 400.

The processing platform 100 is configured to support a workpiece. The first light output module 210 is configured to output a first light spot 212 with an adjustable laser focus, to move upward or downward, and to perform laser processing. The second light output module 220 is configured to output a second light spot 222 for indication.

The imaging module 300 is configured to capture a plurality of images of the workpiece at different distances, each image including the first light spot 212 and the second light spot 222, the different distances being distances between the first light output module 210 and the processing platform 100.

The processor 400 is configured to control movement of the first light output module 210 and operation of the imaging module 300 so as to implement the automatic focusing method of the laser processing apparatus 200 as described above.

The first light output module 210 is implemented as a laser device configured to output a first light spot 212 onto the workpiece. The first light output module 210 is movable upward or downward in a vertical direction relative to the processing platform 100 to accommodate workpieces of different thicknesses. The second light output module 220 is configured to emit infrared light, ultraviolet light, or one or more colored light spots including but not limited to red, blue, and yellow as the second light spot 222 onto the workpiece, the second light spot 222 being primarily used as the position reference. The imaging module 300 is configured to capture the plurality of images of the workpiece at different distances, each image including the first light spot 212 and the second light spot 222, during movement of the first light output module 210. The imaging module 300 optionally includes a camera (such as a complementary metal-oxide-semiconductor (CMOS) camera or a charge-coupled device (CCD) camera), a lens, an image acquisition card, and other components. The imaging module 300 can be positioned on the light output modules (the first light output module 210 and the second light output module 220), on the laser processing apparatus 200, outside the laser processing apparatus 200, or at any other location, and is configured to obtain captured images of the workpiece or the processing platform 100. The captured images can be directly displayed through a user interface, with the first light spot 212 projected by the first light output module 210 and the second light spot 222 projected by the second light output module 220 being displayed in different colors. To distinguish the light spots projected by the first light output module 210 and the second light output module 220 onto the workpiece, the distinction can be achieved by setting the first light output module 210 and the second light output module 220 to output light spots of different colors, or by enabling the imaging module 300 to automatically display the two light spots in different colors after recognition. The specific implementation can be determined according to actual requirements and is not limited herein.

The processor 400 is configured to control movement of the first light output module 210 and operation of the imaging module 300, to process image data fed back from the imaging module 300, to determine an optimal laser focus position, and to send a control signal to the first light output module 210 to adjust the focus point for automatic focusing.

In some embodiments, the processor 400 controls the first light output module 210 to move downward and acquires images captured by the imaging module 300 at different distances, each image including the first light spot 212 and the second light spot 222 on the workpiece, for determining positions of the first light spot 212 and the second light spot 222 at the different distances. The processor 400 is further configured to obtain, from the plurality of images, the target image in which the distance between the first light spot 212 and the second light spot 222 is the shortest, and to use the target image to determine the distance between a processing surface of the workpiece and the first light output module 210 or the thickness of the workpiece.

In some examples, the processor 400 is further configured to adjust the focus point of the first light output module 210 based on the distance between the processing surface of the workpiece and the first light output module 210 or the thickness of the workpiece, so that the focus point is located on the processing surface of the workpiece. This enables automatic focusing, thereby reducing manual involvement, minimizing operational errors, achieving precise processing, and optimizing processing results.

In some embodiments, the processor 400 is configured to control movement of the first light output module 210 and operation of the imaging module 300 based on a processing instruction sent from the terminal device 700, so as to implement automatic focusing. The implementation can be based on the foregoing embodiment of the automatic focusing method.

In some examples, the processor 400 is further configured to calculate, based on position information of the first light spot 212 in the target image, the distance between a processing surface of the workpiece and the first light output module 210 or the thickness of the workpiece. In some examples, the processor 400 is further configured to use the distance between the first light output module 210 and the workpiece corresponding to the target image as the focusing distance, and to adjust the focus point of the first light output module 210 based on the focusing distance so that the focus point is located on the processing surface of the workpiece.

In some examples, the processor 400 is further configured to identify the first light spot 212 and the second light spot 222 in each image, to calculate, based on center points of the first light spot 212 and the second light spot 222 in each image, the distance between the first light spot 212 and the second light spot 222 in each image, and to obtain the target image based on the distances between the first light spot 212 and the second light spot 222 in the plurality of images.

In some embodiments, the emission direction of the first light spot 212 from the first light output module 210 is perpendicular to the surface of the processing platform 100, and the emission direction of the second light spot 222 from the second light output module 220 forms an inclination angle with the surface of the processing platform 100.

A first light beam 211 (such as a laser beam) emitted from the first light output module 210 is oriented perpendicular to the surface of the processing platform 100 and is projected onto the workpiece to form the first light spot 212. The perpendicular emission direction of the first light beam 211 ensures that laser energy is concentrated on a single point of the workpiece so as to achieve precise laser processing operations such as cutting, welding, and drilling. The perpendicular emission direction of the first light beam 211 maintains stability and accuracy of the laser beam while reducing energy loss and processing errors caused by angular deviations. The second light spot 222 (such as an infrared light spot, an ultraviolet light spot, or a colored light spot) emitted from the second light output module 220 forms an inclination angle with the surface of the processing platform 100. The inclination angle of the second light spot 222 causes the second light spot 222 to form a mark on the processing surface of the workpiece that is separated from the first light spot 212, facilitating recognition by an operator or by the device itself and enabling precise adjustment of the position and focus point of the first light output module 210.

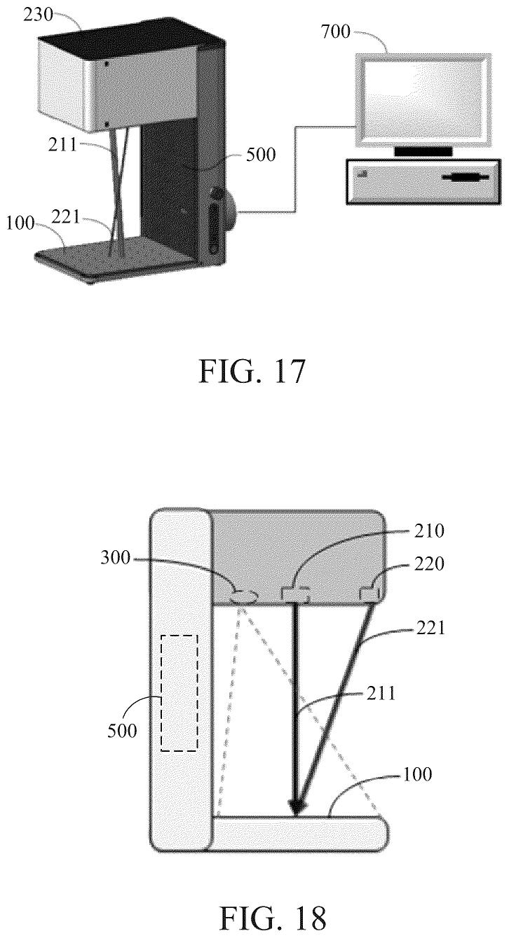

Referring to FIGS. 17 and 18, in some embodiments, the laser processing apparatus 200 further includes a laser head 230, in which the first light output module 210 and the second light output module 220 are integrated.

The first light output module 210 and the second light output module 220 are integrated in the laser head 230, thereby significantly reducing an overall size of the device and making the laser processing apparatus 200 more compact and lightweight. The laser head 230 is also configured with lenses or other mechanisms for collimating and focusing beams, ensuring that the first light beam 211 and the second light beam 221 are efficiently guided to the surface of the workpiece to form clear light spots, thereby reducing beam loss during transmission and improving energy utilization. In addition, the integrated design facilitates integrated control of positions and angles of the first light output module 210 and the second light output module 220, thereby simplifying operation procedures and reducing operational errors.

Referring to FIGS. 17 and 18, in some embodiments, the laser processing apparatus 200 further includes a lifting module 500. The lifting module 500 is operatively connected to the laser head 230 to drive the laser head 230 to move upward or downward, or is configured to drive the first light output module 210 to move upward or downward.

The first light output module 210 and the second light output module 220 can be provided as separate modules or can be integrated in the same laser head 230. The lifting module 500 is optionally configured to drive only the first light output module 210 to move upward or downward so as to obtain multiple images at different distances including the first light output module 210 and the second light output module 220, or to respectively drive the first light output module 210 and the second light output module 220 to move upward or downward. When the first light output module 210 and the second light output module 220 are integrated in the laser head 230, the lifting module 500 is operatively connected to the laser head 230 to drive the laser head 230 to move upward or downward, thereby driving the first light output module 210 and the second light output module 220 to move upward or downward simultaneously.

Taking as an example, the lifting module 500 is configured to drive the laser head 230 to move upward or downward, and can be specifically disposed on the processing platform 100 or at another location of the laser processing apparatus 200 and operatively connected to the laser head 230 to drive the laser head 230 to move toward or away from the processing platform 100. The emission direction of the first light spot 212 from the first light output module 210 is perpendicular to the surface of the processing platform 100, and the emission direction of the second light spot 222 from the second light output module 220 forms an inclination angle with the surface of the processing platform 100. The processor 400 is connected to the lifting module 500 and is configured to control the lifting module 500 to drive the laser head 230 to move so as to adjust a distance between the first light output module 210 and the processing platform 100. The lifting module 500 is specifically provided with a guide rail, a conveyor belt, a sliding block, a pull rod, a push-pull structure, or other devices configured to drive the laser head 230 to move, and the specific configuration can be determined according to actual requirements and is not limited herein. The embodiment in which the lifting module 500 is configured to drive the first light output module 210 and the second light output module 220 to move upward or downward can correspond to the relevant embodiments described above and will not be repeated herein.

In some embodiments, the laser processing apparatus 200 further includes a storage module, the storage module being configured to store a predefined mapping relationship and/or to store coordinate positions (X coordinate and/or Y coordinate) of a center point of the first light spot 212 and position information of the first light output module 210 corresponding to the coordinate positions of the center point of the first light spot 212, such as a distance between a processing surface of the workpiece and the first light output module 210 or a thickness of the workpiece.

The imaging module 300 acquires the plurality of images of the workpiece at different distances by controlling the first light output module 210 to move downward, each image including the first light spot 212 and the second light spot 222, and the obtained plurality of images can also be stored in the storage module, without being limited herein.

The specific embodiment of the laser processing apparatus 200 shown in the present application refers to the foregoing automatic focusing method. Since the laser processing apparatus 200 adopts all the technical solutions of all the above embodiments, it at least has all the beneficial effects brought by the technical solutions of the above embodiments, and therefore, details are not repeated herein.

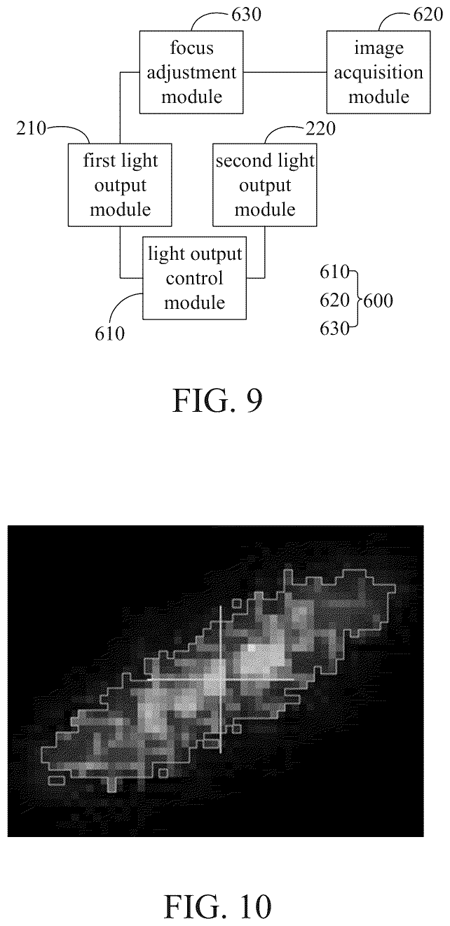

Referring to FIG. 9, the present application further provides an automatic focusing device 600 for the laser processing apparatus 200. The laser processing apparatus 200 includes a first light output module 210 configured to output a light spot for laser processing and a second light output module 220 configured to output a light spot for indication. The automatic focusing device 600 includes a light output control module 610, an image acquisition module 620, and a focus adjustment module 630.

The light output control module 610 is configured to control the first light output module 210 to output the first light spot 212 onto the workpiece and to control the second light output module 220 to output the second light spot 222 onto the workpiece, and is further configured to control the first light output module 210 to move downward. The light output control module 610 is configured to control output states of the first light output module 210 and the second light output module 220 and, by controlling upward and downward movements of the first light output module 210, to assist the image acquisition module 620 in acquiring light spot images at different distances.

The image acquisition module 620 is configured to acquire the plurality of images of the workpiece at different distances, each image including the first light spot 212 and the second light spot 222, during descent of the first light output module 210, so as to obtain the plurality of images, and is further configured to obtain one image corresponding to the smallest distance between the first light spot 212 and the second light spot 222 among the plurality of images, and to use the image as a target image. The image acquisition module 620 is configured to acquire the plurality of images of the workpiece at different distances including the first light spot 212 and the second light spot 222 during downward movement of the first light output module 210, and to obtain the target image by identifying the image in which the distance between the first light spot 212 and the second light spot 222 is the shortest, thereby assisting in further implementing automatic focusing.

The focus adjustment module 630 is configured to determine, based on the target image, the distance between the processing surface of the workpiece and the first light output module 210 or the thickness of the workpiece.

The focus adjustment module 630 is further configured to adjust the focus point of the first light output module 210 based on the distance between the processing surface of the workpiece and the first light output module 210 or the thickness of the workpiece, so that the focus point is located on the processing surface of the workpiece. The focus adjustment module 630, based on the target image provided by the image acquisition module 620, calculates a distance and a direction for focus adjustment according to a positional relationship between the first light spot 212 and the second light spot 222 in the target image, and then drives the first light output module 210 to perform a corresponding adjustment so as to adjust its focus position and accurately position the focus point on the processing surface of the workpiece.

Accordingly, automatic focusing can be achieved, reducing manual involvement, effectively minimizing operational errors, lowering operational difficulty, and, after adjusting the focus point of the first light output module 210, controlling processing to achieve more precise machining and optimize processing results.

In some examples, the focus adjustment module 630 is further configured to calculate, based on position information of the first light spot 212 in the target image, the distance between the processing surface of the workpiece and the first light output module 210 or the thickness of the workpiece, and to adjust the focus point of the first light output module 210 based on the distance between the processing surface of the workpiece and the first light output module 210 or the thickness of the workpiece so that the focus point is located on the processing surface.

In some examples, the focus adjustment module 630 is further configured to obtain an X coordinate and/or a Y coordinate of a center point of the first light spot 212 in the target image, and to calculate, based on the X coordinate and/or the Y coordinate of the center point of the first light spot 212 and a predefined mapping relationship, the distance between the processing surface of the workpiece and the first light output module 210 or the thickness of the workpiece.

In some examples, the image acquisition module 620 is further configured, in response to one of the plurality of images including a center point of the first light spot 212 coinciding with a center point of the second light spot 222, to determine that the image corresponds to the smallest distance between the first light spot 212 and the second light spot 222. In response to none of the plurality of images including the center point of the first light spot 212 coinciding with the center point of the second light spot 222, the image acquisition module 620 is further configured to determine, based on distances between the first light spot 212 and the second light spot 222 in the respective images, one of the plurality of images that corresponds to the smallest distance.

In some examples, the image acquisition module 620 is further configured to identify the first light spot 212 and the second light spot 222 in each image, to calculate, based on center points of the first light spot 212 and the second light spot 222 in each image, a distance between the first light spot 212 and the second light spot 222 in each image, and to obtain the target image based on the distances between the first light spot 212 and the second light spot 222 in the plurality of images.

The above modules can be implemented by a general computing device and can be modules in the general computing device. The general computing device typically includes a processor 400 and a memory, the memory being configured to store instructions which, when executed by the processor 400, cause the computing device to perform the steps or program modules of the present application. The modules can be centralized in a single computing device or distributed across a network formed by multiple computing devices. Optionally, they can be implemented by program code executable by the computing device, such that the program code can be stored in a storage device and executed by the computing device. In some cases, the steps shown or described herein can be performed in an order different from that described, or each of the modules can be implemented as a separate integrated circuit module, or two or more of the modules or steps can be implemented as a single integrated circuit module. The present invention is not limited to any particular combination of hardware and software.

The specific embodiments of the automatic focusing device 600 for the laser processing apparatus 200 shown in the present application is implemented with reference to the foregoing laser processing apparatus 200. Since the automatic focusing device 600 adopts all the technical solutions of the above embodiments, it possesses all the advantageous effects brought by the technical solutions of those embodiments and will not be described again in detail herein.

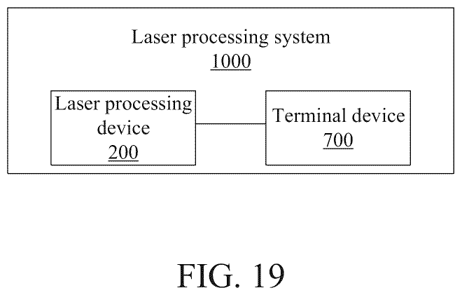

The present application further provides a laser processing system 1000. Referring to FIG. 19, FIG. 19 is a schematic structural diagram of some embodiments of the laser processing system 1000 provided in the present application. The laser processing system 1000 includes a laser processing apparatus 200 and a terminal device 700.

The laser processing apparatus 200 includes a first light output module 210, a second light output module 220, and an imaging module 300. The first light output module 210 is configured to output a light spot for laser processing. The second light output module 220 is configured to output a light spot for indication. The laser focus point of the first light output module 210 is adjustable.

The terminal device 700 is configured to control the first light output module 210 to emit a first light spot 212 onto a workpiece, and to control the second light output module 220 to emit a second light spot 222 onto the workpiece. It is further configured to control the first light output module 210 to move downward and to control the imaging module 300 to capture a plurality of images of the workpiece including the first light spot 212 and the second light spot 222 at different distances. Among these images, the image in which the distance between the first light spot 212 and the second light spot 222 is the shortest is selected as the target image. Based on the target image, the distance between the processing surface of the workpiece and the first light output module 210, or the thickness of the workpiece, is determined.

The terminal device 700 is further configured to adjust the focus point of the first light output module 210 based on the distance between the processing surface of the workpiece and the first light output module 210, or the thickness of the workpiece, so that the focal point is positioned on the processing surface of the workpiece.

The terminal device 700 is configured to receive input instructions entered by a user through input devices such as control buttons, a touch screen, a keyboard, or a mouse, and to issue corresponding focusing commands to the laser processing apparatus 200 based on the received input instructions. The lifting module 500, imaging module 300, and other components of the laser processing apparatus 200 then perform corresponding operations to achieve one-click automatic focusing. In some embodiments, the terminal device 700 is responsible for controlling the output status of the first light output module 210 and the second light output module 220, including power on/off, output intensity, and spot position. This ensures that the first light spot 212 for laser processing and the second light spot 222 for indication are accurately projected onto the processing surface of the workpiece. The terminal device 700 is further configured to issue lifting control commands to control the downward movement of the first light output module 210. In some other embodiments, the terminal device 700 is also used to control the upward movement of the first light output module 210. During the upward or downward movement of the first light output module 210, the terminal device 700 sends acquisition instructions to the imaging module 300 to trigger image capture, thereby obtaining images of the workpiece that include the first light spot 212 and the second light spot 222 at different distances. The terminal device 700 receives image data acquired by the imaging module 300 and performs processing and analysis. In some embodiments, the terminal device 700 is configured to identify the positions of the first light spot 212 and the second light spot 222 based on the acquired images, calculate the distance between the two, and identify the image in which the distance is the shortest as the target image. The terminal device 700 is further configured to calculate the distance and direction by which the first light output module 210 needs to be adjusted based on the positional relationship between the first light spot 212 and the second light spot 222 in the target image. The terminal device 700 then sends a focus adjustment instruction to the first light output module 210 to control the corresponding adjustment, ensuring that the focal point is accurately positioned on the processing surface of the workpiece.

The modules within the laser processing apparatus 200 cooperate with the terminal device 700 to jointly implement automatic focusing and precise processing functions for laser machining. This not only improves processing accuracy and efficiency but also reduces operational complexity. By adjusting the focus point of the first light output module 210 and performing processing, more precise machining can be achieved, thereby optimizing the processing result.

The terminal device 700 controls various modules within the laser processing apparatus 200 based on the automatic focusing method provided in the above embodiments, thereby achieving automatic focusing. In some embodiments, during the automatic focusing process, the terminal device 700 issues an automatic focusing command to the laser processing apparatus 200 and controls the corresponding modules, such as the first light output module 210, the second light output module 220, and the imaging module 300, to perform automatic focusing according to the automatic focusing command.

The present application further provides a computer-readable storage medium storing instructions of the automatic focusing method. The processor 400 executes the instructions to implement the automatic focusing method for the laser processing apparatus 200 as described above.

The computer-readable storage medium provided in the present application can be, for example, a USB flash drive, but is not limited to electrical, magnetic, optical, electromagnetic, infrared, or semiconductor systems, devices, or apparatuses, or any combination thereof. More specific examples of the computer-readable storage medium include, but are not limited to: electrical connections with one or more wires, portable computer disks, hard disks, random access memory (RAM), read-only memory (ROM), erasable programmable read-only memory (EPROM) or flash memory, optical fibers, portable compact disc read-only memory (CD-ROM), optical storage devices, magnetic storage devices, or any suitable combination of the above. In these embodiments, the computer-readable storage medium can be any tangible medium that stores a program usable by, or in conjunction with, an instruction execution system, apparatus, or device. The program code stored on the computer-readable storage medium is transmitted via any suitable medium, including but not limited to electrical wires, optical fibers, radio frequency (RF), or any suitable combination thereof.

The computer-readable storage medium described above is included within a computer device or exists independently without being installed in the computer device.

The computer-readable storage medium is configured to carry one or more programs which, when executed by the computer device, enable the computer device to: control the first light output module 210 to emit the first light spot 212 onto the workpiece, and control the second light output module 220 to emit the second light spot 222 onto the workpiece; control the first light output module 210 to move downward and acquire the plurality of images of the workpiece including the first light spot 212 and the second light spot 222 at different distances; determine one image among the plurality of images corresponding the smallest distance between the first light spot 212 and the second light spot 222, and designate it as the target image; and adjust the focus point of the first light output module 210 based on the target image so that the focal point is located on the processing surface of the workpiece.

The computer program code for performing the operations of the present application is written in one or more programming languages, or a combination thereof. These programming languages include object-oriented programming languages such as Java, Smalltalk, or C++, as well as conventional procedural programming languages such as the “C” language or similar languages. The program code is executed entirely on a user computer, partly on a user computer, as a standalone software package, partly on a user computer and partly on a remote computer, or entirely on a remote computer or server. In the case involving a remote computer, the remote computer is connected to the user computer through any type of network, including a local area network (LAN) or a wide area network (WAN), or is connected to an external computer via the Internet using an Internet service provider.

The flowcharts and block diagrams in the accompanying drawings illustrate possible system architectures, functions, and operations for various embodiments of the system, method, and computer program product described in the present application. Each block in the flowcharts or block diagrams may represent a module, program segment, or portion of code that includes one or more executable instructions for implementing specified logical functions. It should also be noted that, in some alternative implementations, the functions indicated in the blocks may be performed in an order different from that shown in the drawings. For example, two blocks shown in succession may in fact be executed substantially concurrently or in reverse order, depending on the functionality involved. It should further be noted that each block in the block diagrams and/or flowcharts, as well as combinations of blocks, may be implemented by a dedicated hardware-based system for performing the specified functions or operations, or by a combination of dedicated hardware and computer-executable instructions.

In the embodiments of the present application, the modules involved are implemented in software or alternatively in hardware. The names of the modules do not impose any limitation on the functional units themselves and are not intended to be limiting.

The readable storage medium provided in the present application is a computer-readable storage medium that stores computer-readable program instructions (i.e., a computer program) for executing the above-described automatic focusing method for the laser processing apparatus 200. This addresses the problem of inability to perform automatic focusing. Compared with the prior art, the advantageous effects of the computer-readable storage medium provided in the present application are the same as those of the automatic focusing method of the laser processing apparatus 200 described in the above embodiments, and will not be repeated herein.

The present application further provides a computer device. The computer device includes at least one processor 400 and a memory in communication with the at least one processor 400. The memory is configured to store the automatic focusing program executable by the at least one processor 400, such that the at least one processor 400 is configured to perform the automatic focusing method for the laser processing apparatus 200 as described in the above embodiments.

The computer device in the embodiments of the present application includes, but is not limited to, mobile terminals such as mobile phones, notebook computers, digital broadcast receivers, PDAs (Personal Digital Assistants), PADs (Portable Application Descriptions, e.g., tablet computers), PMPs (Portable Media Players), and in-vehicle terminals (such as vehicle-mounted navigation systems), as well as fixed terminals such as digital TVs and desktop computers. The computer device shown in the present application is merely an example and should not be construed as limiting the functionality or scope of use of the embodiments of the present application.

The computer device includes a control component such as a processing unit (e.g., a central processing unit, a graphics processing unit, etc.) configured to perform various operations and processes based on programs stored in read-only memory (ROM) or programs loaded from a storage device into random access memory (RAM). The RAM also stores various programs and data required for the operation of the computer device. The processing unit, ROM, and RAM are interconnected via a bus. An input/output (I/O) interface is also connected to the bus. Typically, the following systems are connected to the I/O interface: an input device such as a touch screen, touchpad, keyboard, mouse, image sensor, microphone, accelerometer, gyroscope, or the like; an output device such as a liquid crystal display (LCD), speaker, vibrator, or the like; a storage device such as magnetic tape or a hard disk drive; and a communication device. The communication device allows the computer device to exchange data with other devices via wired or wireless communication. In some embodiments, according to the embodiments disclosed in the present application, the process described above with reference to the flowchart is implemented as a computer software program. For example, the embodiments of the present application include a computer program product comprising a computer program carried on a computer-readable medium. The computer program includes program code for executing the method illustrated in the flowchart. In such embodiments, the computer program is downloaded and installed via a communication device from a network, installed from a storage device, or installed from ROM. When executed by a processing unit, the computer program performs the functions defined in the method of the disclosed embodiments of the present application.

The computer device provided in the present application adopts the automatic focusing method of the laser processing apparatus 200 as described in the above embodiments, thereby solving the problem of the inability to perform automatic focusing. Compared with the prior art, the advantageous effects of the computer device are the same as those of the automatic focusing method for the laser processing apparatus 200 described in the foregoing embodiments. Other technical features of the computer device are also consistent with those disclosed in the method of the preceding embodiment and are therefore not described again herein.

It is understood that each part disclosed in the present application can be implemented using hardware, software, firmware, or any combination thereof. In the description of the above embodiments, specific features, structures, materials, or characteristics may be combined in any suitable manner in one or more embodiments or examples.

The foregoing description only provides specific embodiments of the present application and shall not be construed as limiting. Any modifications or substitutions that can be readily conceived by those skilled in the art within the scope of the disclosed technical content shall be encompassed within the protection scope of the present application. Therefore, the scope of protection shall be defined by the claims.

The present application further provides a computer program product including a computer program configured to perform the steps of the automatic focusing method for the laser processing apparatus 200 when executed by the processor 400.

The computer program product provided in the present application addresses the technical problem of the inability to perform automatic focusing. Compared with the prior art, the advantageous effects of the computer program product are the same as those of the automatic focusing method for the laser processing apparatus 200 described in the foregoing embodiments, and thus will not be repeated here.

The foregoing description is merely exemplary of optional embodiments of the present application and should not be construed as limiting the scope of the present application. Any equivalent modifications or transformations made under the inventive concept of the present application, based on the content disclosed in the specification and drawings, or any direct or indirect applications to other related technical fields, are intended to be included within the scope of protection of the present application.

What is claimed is:

1. An automatic focusing method for a laser processing apparatus, the laser processing apparatus comprising a first light output module and a second light output module, the first light output module being configured to emit a light spot for laser processing, and the second light output module being configured to emit a light spot for indication, the automatic focusing method comprising:
controlling the first light output module to emit a first light spot onto a workpiece, and controlling the second light output module to emit a second light spot onto the workpiece;
controlling the first light output module to move downward, and acquiring a plurality of images of the workpiece at different distances, each of the plurality of images including the first light spot and the second light spot; and
determining, based on the plurality of images, a distance between a processing surface of the workpiece and the first light output module or a thickness of the workpiece.

2. The automatic focusing method for a laser processing apparatus according to claim 1, wherein the step of determining, based on the plurality of images, a distance between a processing surface of the workpiece and the first light output module or a thickness of the workpiece comprises:
obtaining one of the plurality of images as a target image that corresponds to a smallest distance between the first light spot and the second light spot; and
determining, based on the target image, a distance between a processing surface of the workpiece and the first light output module or a thickness of the workpiece.

3. The automatic focusing method for a laser processing apparatus according to claim 1, wherein after the step of determining, based on the plurality of images, a distance between a processing surface of the workpiece and the first light output module or a thickness of the workpiece, the automatic focusing method further comprises:
adjusting a focal point of the first light output module based on the distance between the processing surface of the workpiece and the first light output module or the thickness of the workpiece to position the focal point on the processing surface.

4. The automatic focusing method for a laser processing apparatus according to claim 3, wherein the step of adjusting the focal point of the first light output module based on the distance between the processing surface of the workpiece and the first light output module to position the focal point on the processing surface comprises:
determining a movement distance of the first light output module based on the distance between the processing surface of the workpiece and the first light output module; and
controlling the first light output module to move upward or downward to adjust the focal point, so as to position the focal point on the processing surface.

5. The automatic focusing method for a laser processing apparatus according to claim 3, wherein the step of adjusting the focal point of the first light output module based on the thickness of the workpiece to position the focal point on the processing surface comprises:
determining a movement distance of the first light output module based on the thickness of the workpiece; and
controlling the first light output module to move upward or downward to adjust the focal point, so as to position the focal point on the processing surface.

6. The automatic focusing method for a laser processing apparatus according to claim 2, wherein the step of determining, based on the target image, a distance between a processing surface of the workpiece and the first light output module or a thickness of the workpiece comprises:
calculating the distance between the processing surface of the workpiece and the first light output module or the thickness of the workpiece based on position information of the first light spot in the target image.

7. The automatic focusing method for a laser processing apparatus according to claim 6, wherein the step of calculating the distance between the processing surface of the workpiece and the first light output module or the thickness of the workpiece based on the position information of the first light spot in the target image comprises:
acquiring an X coordinate and/or a Y coordinate of a center point of the first light spot in the target image; and
calculating the distance between the processing surface of the workpiece and the first light output module or the thickness of the workpiece based on the X coordinate and/or the Y coordinate of the center point of the first light spot and a predefined mapping relationship.

8. The automatic focusing method for a laser processing apparatus according to claim 2, wherein the step of determining, based on the target image, a distance between a processing surface of the workpiece and the first light output module or a thickness of the workpiece comprises:
determining the distance between the processing surface of the workpiece and the first light output module based on a descending distance of the first light output module corresponding to the target image.

9. The automatic focusing method for a laser processing apparatus according to claim 2, wherein the step of determining, based on the plurality of images, the thickness of the workpiece comprises:
determining the distance between the processing surface of the workpiece and the first light output module based on a descending distance of the first light output module corresponding to the target image, and
determining the thickness of the workpiece based on the distance between the processing surface of the workpiece and the first light output module.

10. The automatic focusing method for a laser processing apparatus according to claim 2, wherein the step of obtaining one of the plurality of images as the target image that corresponds to the smallest distance between the first light spot and the second light spot comprises:
in response to one of the plurality of images including a center point of the first light spot coinciding with a center point of the second light spot, determining that the image corresponding to the smallest distance between the first light spot and the second light spot; and
in response to none of the plurality of images including the center point of the first light spot coinciding with the center point of the second light spot, determining one of the plurality of images that corresponds to the smallest distance between the first light spot and the second light spot.

11. The automatic focusing method for a laser processing apparatus according to claim 2, wherein the step of obtaining one of the plurality of images as the target image that corresponds to the smallest distance between the first light spot and the second light spot comprises:
identifying the first light spot and the second light spot in each of the plurality of images;
calculating a distance between the first light spot and the second light spot in each of the plurality of images based on a center point of the first light spot and a center point of the second light spot; and
obtaining the target image based on distances between the first light spot and the second light spot in all of the plurality of images.

12. The automatic focusing method for a laser processing apparatus according to claim 11, wherein the step of calculating the distance between the first light spot and the second light spot in each of the plurality of images based on the center point of the first light spot and the center point of the second light spot comprises:
obtaining multiple first target pixels from a set of pixels corresponding to the first light spot in the image, the multiple first target pixels including pixel values greater than a first pixel threshold, and obtaining coordinates of the multiple first target pixels;
calculating an average value of the coordinates of the multiple first target pixels to obtain a coordinate of the center point of the first light spot;
obtaining multiple second target pixels from a set of pixels corresponding to the second light spot in the image, the multiple second target pixels including pixel values greater than a second pixel threshold, and obtaining coordinates of the multiple second target pixels;
calculating an average value of the coordinates of the multiple second target pixels to obtain a coordinate of the center point of the second light spot; and
calculating the distance between the first light spot and the second light spot in the image based on the center point of the first light spot and the center point of the second light spot.

13. The automatic focusing method for a laser processing apparatus according to claim 1, wherein the first light spot and the second light spot have different colors.

14. The automatic focusing method for a laser processing apparatus according to claim 1, wherein a processing light spot emitted by the first light output module has a higher power than the first light spot, and the processing light spot is used to effect a change in the workpiece.

15. The automatic focusing method for a laser processing apparatus according to claim 1, wherein the first light output module and the second light output module move upward or downward simultaneously.

16. The automatic focusing method for a laser processing apparatus according to claim 1, wherein projection directions of the first light spot and the second light spot intersect.

17. The automatic focusing method for a laser processing apparatus according to claim 1, wherein the first light spot is emitted in a direction perpendicular to a surface of the processing platform, and the second light spot is emitted in a direction forming an inclination angle with respect to the surface of the processing platform.

18. A laser processing apparatus, comprising:
a processing platform configured to support a workpiece;
a first light output module configured to emit a first light spot onto the workpiece, a laser focus point of the first light output module being adjustable, the first light output module being movable upward or downward, the first light output module being configured for laser processing;
a second light output module configured to emit a second light spot for indication;
an imaging module configured to acquire a plurality of images of the workpiece at different distances, the different distances being distances between the first light output module and the processing platform; and
a processor configured to control movement of the first light output module and operation of the imaging module, the processor being configured to implement an automatic focusing method according to claim 1.

19. The laser processing apparatus according to claim 18, wherein the first light spot is emitted in a direction perpendicular to a surface of the processing platform, and the second light spot is emitted in a direction forming an inclination angle with respect to the surface of the processing platform.

20. The laser processing apparatus according to claim 18, wherein the laser processing apparatus further comprises a laser head, the first light output module and the second light output module being integrally disposed in the laser head.

21. The laser processing apparatus according to claim 20, wherein the laser processing apparatus further comprises a lifting module operatively connected to the laser head and configured to drive the laser head or the first light output module to move upward or downward.

22. The laser processing apparatus according to claim 18, wherein the processor is further configured to:
calculate the distance between the processing surface of the workpiece and the first light output module or the thickness of the workpiece based on position information of the first light spot in a target image, the target image being one of the plurality of images that corresponds to a smallest distance between the first light spot and the second light spot.

23. The laser processing apparatus according to claim 18, wherein the processor is further configured to:
adjust the focal point of the first light output module based on the distance between the processing surface of the workpiece and the first light output module or the thickness of the workpiece to position the focal point on the processing surface.

24. The laser processing apparatus according to claim 18, wherein the processor is configured to:
use a distance between the first light output module and the workpiece corresponding to a target image as a focusing distance, the target image being one of the plurality of images that corresponds to a smallest distance between the first light spot and the second light spot; and
adjust the focal point of the first light output module based on the focusing distance, so as to position the focal point on the processing surface.

25. The laser processing apparatus according to claim 24, wherein the processor is configured to:
identify the first light spot and the second light spot in each of the plurality of images;
calculate a distance between the first light spot and the second light spot in each of the plurality of images based on a center point of the first light spot and a center point of the second light spot; and
obtain the target image based on distances between the first light spot and the second light spot in all of the plurality of images.

26. The laser processing apparatus according to claim 18, wherein the first light spot and the second light spot have different colors.

27. A laser processing system, comprising:
a laser processing apparatus comprising:
a first light output module configured to emit a light spot for laser processing, and a focal point of the first light output module is adjustable;
a second light output module configured to emit a light spot for indication; and
an imaging module configured to acquire a plurality of images of the workpiece at different distances, the different distances being distances between the first light output module and the processing platform; and
a terminal device configured to:
control the first light output module to emit a first light spot onto a workpiece and control the second light output module to emit a second light spot onto the workpiece;
control the first light output module to move downward;
control the imaging module to acquire a plurality of images of the workpiece at different distances, each of the plurality of images including the first light spot and the second light spot; and
determine, based on the plurality of images, a distance between a processing surface of the workpiece and the first light output module or a thickness of the workpiece.

28. The laser processing system according to claim 27, wherein the terminal device is configured to adjust the focal point of the first light output module based on the distance between the processing surface of the workpiece and the first light output module or the thickness of the workpiece to position the focal point on the processing surface.

29. The laser processing system according to claim 27, wherein the terminal device is configured to issue an automatic focusing command to the laser processing apparatus, and to control at least one of the first light output module, the second light output module, and the imaging module based on the automatic focusing command.

30. A non-transitory computer-readable storage medium storing instructions that, when executed by a processor, cause the processor to perform steps of an automatic focusing method according to claim 1.
